(19) United States
(12) Patent Application Publication
(10) Pub. No.: US 2026/0134258 A1
(43) Pub. Date: May 14, 2026

(54) IMAGE AND VIDEO TOKENIZERS

(71) Applicant: NVIDIA Corporation, Santa Clara, CA (US)

(72) Inventors: Fitsum Reda, Santa Clara, CA (US); Jinwei Gu, Sunnyvale, CA (US); Xian Liu, Menlo Park, CA (US); Songwei Ge, Greenbelt, MD (US); Ting-Chun Wang, Santa Clara, CA (US); Haoxiang Wang, Champaign, IL (US); Ming-Yu Liu, Redwood City, CA (US)

(21) Appl. No.: 19/090,680

(22) Filed: Mar. 26, 2025

Related U.S. Application Data
(60) Provisional application No. 63/718,839, filed on Nov. 11, 2024.

(51) Int. Cl. G06N 3/0455; G06T 11/00

(52) U.S. Cl. CPC G06N 3/0455; G06T 11/00

(57) ABSTRACT

Neural network architectures and machine learning techniques that support tokenization of raw visual input to generate a compact representation in a latent feature space as well as de-tokenization to generate raw visual output. In at least one embodiment, tokenization systems and methods leverages wavelet transforms and causal operations to capture spatial and temporal dependencies in the raw visual input.

### CROSS-REFERENCE TO RELATED APPLICATIONS

This application claims the benefit of U.S. Provisional Application No. 63/718,839, filed Nov. 11, 2024, which is hereby incorporated by reference in its entirety.

### FIELD

The present disclosure relates to visual tokenization. In at least one embodiment, one or more processors to perform tokenization of visual input and reconstruction of visual output using tokenizer encoders and tokenizer decoders that leverage wavelet transforms and causal operations to capture spatial and temporal dependencies in raw visual input.

### BACKGROUND

Tokenizers are fundamental building blocks of modern generative AI. They transform raw data (e.g., in the form of text, an image, or a video) into more efficient and compressed representations by learning a latent space discovered in an unsupervised manner. For example, visual tokenizers map redundant and implicit visual data-such as images and videos-into compact semantic tokens. This process is crucial for both enabling efficient training of large-scale generative models and democratizing inference on limited computational resources.

Visual tokenizers come in two varieties: continuous and discrete. Continuous tokenizers encode visual data into continuous latent embeddings, as shown in latent diffusion models. Continuous latent embeddings are suitable for models that generate data by sampling from continuous distributions. Discrete tokenizers encode visual data into discrete latent codes, mapping them into quantized indices, as seen, e.g., in autoregressive transformers. Discretization is required for models that generate data by optimizing the cross-entropy loss, such as the generative pretrained transformer (GPT) models.

A significant challenge in tokenizer design is delivering high compression rates while simultaneously preserving visual information. Achieving this balance is critical: high compression reduces storage and computational demands (thereby promoting efficiency in both model training and inference) while minimizing loss of visual information maximizes the quality of reconstructed visual representations provided as output.

### BRIEF DESCRIPTION OF THE DRAWINGS

Subject matter of the present disclosure is described in detail below with reference to the attached drawing figures. Features described and/or illustrated herein can be used alone and/or combined in different combinations. The attached drawings illustrate the following:

FIG. 1A is a flow diagram illustrating a method for tokenizing visual input to provide a compact representation thereof and for de-tokenizing output tokens to provide a pixel-space representation thereof, in accordance with an embodiment;

FIG. 1B is a flow diagram illustrating a method for training a visual tokenizer to tokenize visual input and to de-tokenize output tokens to provide a pixel-space representation thereof, in accordance with an embodiment;

FIG. 2A is a block diagram illustrating a system, in accordance with an embodiment, for tokenizing visual input to provide a compact representation thereof and for de-tokenizing output tokens to provide a pixel-space representation thereof;

FIG. 2B is a block diagram illustrating a tokenizer encoder, in accordance with an embodiment;

FIG. 2C is a block diagram illustrating a tokenizer decoder, in accordance with an embodiment;

FIG. 3A illustrates a temporal causality mechanism, in accordance with an embodiment, where input video frames are processed through grouped intermediate outputs and further refined by spatio-temporal convolution and attention operations;

FIG. 3B provides a visualization of continuous tokens, in accordance with an embodiment;

FIG. 3C provides a visualization of discrete tokens, in accordance with an embodiment;

FIG. 3D plots reconstruction quality versus spatio-temporal compression rate for a variety of different continuous tokenizers, including a continuous tokenizer according to an embodiment;

FIG. 3E plots reconstruction quality versus spatio-temporal compression rate for a variety of different discrete tokenizers, including a discrete tokenizer according to an embodiment;

FIG. 4 is a conceptual diagram of a processing system implemented using a PPU, suitable for use in implementing some embodiments of the present disclosure;

FIG. 5A illustrates an exemplary system in which the various architecture and/or functionality of the various previous embodiments may be implemented;

FIG. 5B illustrates components of an exemplary system that can be used to train and utilize machine learning, in at least one embodiment; and

FIG. 6 illustrates an exemplary streaming system suitable for use in implementing some embodiments of the present disclosure.

### DETAILED DESCRIPTION

The present disclosure provides neural network architectures and machine learning techniques that support novel techniques for tokenizing raw visual input (provided, e.g., in the form of an image or in the form of a video consisting of a plurality of frames) to provide a compact representation of the raw visual input in a latent feature space. The techniques of the present disclosure (i) convert raw visual input from a pixel space to a wavelet space to provide a wavelet space representation, (ii) convert the wavelet space representation from the wavelet space to a latent feature space to provide a plurality of input tokens, (iii) convert a plurality of output tokens from the latent feature space to the wavelet space to provide a wavelet space representation of an output, and (iv) convert the wavelet space representation of the output back to the pixel space to provide visual output. As compared to prior art techniques for tokenizing raw visual input, the techniques of the present disclosure provide for substantial improvements in compression-quality trade-off while simultaneously decreasing runtime. Given a predetermined compression ratio (i.e., for an intermediate latent feature space representation), the techniques of the present disclosure convert raw visual input into the intermediate latent feature space and then generate, as compared to prior art techniques, higher-quality visual output reconstructed therefrom—and do so with shorter runtimes.

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

The systems and methods described herein may be used by, without limitation, non-autonomous vehicles, semi-autonomous vehicles (e.g., in one or more advanced driver assistance systems (ADAS)), piloted and un-piloted robots or robotic platforms, warehouse vehicles, off-road vehicles, vehicles coupled to one or more trailers, flying vessels, boats, shuttles, emergency response vehicles, motorcycles, electric or motorized bicycles, aircraft, construction vehicles, trains, underwater craft, remotely operated vehicles such as drones, and/or other vehicle types. Further, the systems and methods described herein may be used for a variety of purposes, by way of example and without limitation, for machine control, machine locomotion, machine driving, synthetic data generation, model training or updating, perception, augmented reality, virtual reality, mixed reality, robotics, security and surveillance, simulation and digital twinning, autonomous or semi-autonomous machine applications, deep learning, environment simulation, object or actor simulation and/or digital twinning, data center processing, conversational AI, generative AI, light transport simulation (e.g., ray-tracing, path tracing, etc.), collaborative content creation for 3D assets, cloud computing and/or any other suitable applications.

Disclosed embodiments may be comprised in a variety of different systems such as automotive systems (e.g., a control system for an autonomous or semi-autonomous machine, a perception system for an autonomous or semi-autonomous machine), systems implemented using a robot, aerial systems, medical systems, boating systems, smart area monitoring systems, systems for performing deep learning operations, systems for performing simulation operations, systems for performing digital twin operations, systems implemented using an edge device, systems incorporating one or more virtual machines (VMs), systems for performing synthetic data generation operations, systems implemented at least partially in a data center, systems for performing conversational AI operations, systems for performing generative AI operations, systems implemented using large language models (LLMs), systems implemented using vision language models (VLMs), systems for performing light transport simulation, systems for performing collaborative content creation for 3D assets, systems implemented at least partially using cloud computing resources, and/or other types of systems.

In some examples, the machine learning model(s) (e.g., deep neural networks, language models, LLMs, VLMs, multi-modal language models, perception models, tracking models, fusion models, transformer models, diffusion models, encoder-only models, decoder-only models, encoder-decoder models, neural rendering field (NERF) models, etc.) described herein may be packaged as a microservice—such an inference microservice (e.g., NVIDIA NIMs)—which may include a container (e.g., an operating system (OS)-level virtualization package) that may include an application programming interface (API) layer, a server layer, a runtime layer, and/or at least one model “engine.” For example, the inference microservice may include the container itself and the model(s) (e.g., weights and biases). In some instances, such as where the machine learning model(s) is small enough (e.g., has a small enough number of parameters), the model(s) may be included within the container itself. In other examples-such as where the model(s) is large—the model(s) may be hosted/stored in the cloud (e.g., in a data center) and/or may be hosted on-premises and/or at the edge (e.g., on a local server or computing device, but outside of the container). In such embodiments, the model(s) may be accessible via one or more APIs-such as REST APIs. As such, and in some embodiments, the machine learning model(s) described herein may be deployed as an inference microservice to accelerate deployment of a model(s) on any cloud, data center, or edge computing system, while ensuring the data is secure. For example, the inference microservice may include one or more APIs, a pre-configured container for simplified deployment, an optimized inference engine (e.g., built using a standardized AI model deployment an execution software, such as NVIDIA's Triton Inference Server, and/or one or more APIs for high performance deep learning inference, which may include an inference runtime and model optimizations that deliver low latency and high throughput for production applications—such as NVIDIA's TensorRT), and/or enterprise management data for telemetry (e.g., including identity, metrics, health checks, and/or monitoring).

The machine learning model(s) described herein may be included as part of the microservice along with an accelerated infrastructure with the ability to deploy with a single command and/or orchestrate and auto-scale with a container orchestration system on accelerated infrastructure (e.g., on a single device up to data center scale). As such, the inference microservice may include the machine learning model(s) (e.g., that has been optimized for high performance inference), an inference runtime software to execute the machine learning model(s) and provide outputs/responses to inputs (e.g., user queries, prompts, etc.), and enterprise management software to provide health checks, identity, and/or other monitoring. In some embodiments, the inference microservice may include software to perform in-place replacement and/or updating to the machine learning model(s). When replacing or updating, the software that performs the replacement/updating may maintain user configurations of the inference runtime software and enterprise management software.

The present disclosure provides a novel method for tokenizing raw visual input, e.g., in the form of an image or a video, by transforming the raw visual input into a set of tokens in a latent feature space. The method involves transforming the raw visual input from a pixel space into an intermediate wavelet domain representation via a wavelet transform and subsequently encoding the intermediate wavelet domain representation into the latent feature space. In at least one embodiment, the encoding enforces temporal causality. The method supports both continuous and discrete tokenization, providing either continuous tokens (e.g., latent embeddings) or discrete tokens (e.g., latent codes mapped to quantized indices).

The present disclosure provides a novel method for de-tokenizing output tokens to provide raw visual output, e.g., in the form of an image or a video. The method involves decoding the output tokens from a latent feature space to provide an intermediate wavelet domain representation and subsequently transforming the intermediate wavelet domain representation into the pixel space via an inverse wavelet transform. In at least one embodiment, the decoding enforces temporal causality. The method supports de-tokenization of both continuous tokens (e.g., latent embeddings) and discrete tokens (e.g., latent codes mapped to quantized indices).

The present disclosure provides a novel encoder-decoder architecture for tokenizing raw visual input. The encoder-decoder architecture operates in the wavelet transform space and includes both a tokenizer encoder and a tokenizer decoder. The tokenizer encoder includes a wavelet transform block and a plurality of downsampling encoder blocks, while the tokenizer decoder includes a plurality of upsampling decoder blocks and an inverse wavelet transform block. In at least one embodiment, each of the downsampling encoder blocks provides for causal downsampling and causal spatio-temporal attention. In at least one embodiment, each of the downsampling encoder blocks performs a factorized convolution operation in which a 2D spatial downsampling convolution is followed by a ID temporal downsampling convolution. In at least one embodiment, each of the downsampling encoder blocks performs a factorized attention operation in which a 2D spatial attention operation is followed by a 1D temporal attention operation. In at least one embodiment, each of the upsampling decoder blocks provides for causal upsampling and causal spatio-temporal attention. In at least one embodiment, each of the upsampling decoder blocks performs a factorized convolution operation in which a 2D spatial upsampling convolution is followed by a ID temporal upsampling convolution. In at least one embodiment, each of the upsampling encoder blocks performs a factorized attention operation in which a 2D spatial attention operation is followed by a ID temporal attention operation. In at least one embodiment, the tokenizer encoder is provided without the tokenizer decoder. In at least one embodiment, the tokenizer decoder is provided without the tokenizer encoder.

The present disclosure provides a novel method for training an encoder-decoder architecture to tokenize raw visual input to provide input tokens and to de-tokenize output tokens to provide raw visual output. The training method optimizes parameters of the encoder and of the decoder to minimize a reconstruction loss that measures a difference between a ground truth training image and a reconstructed image. In at least one embodiment, the training method is a two-stage training method that includes: (i) a first stage in which (a) an £1 loss and (b) a perceptual loss are minimized; and (ii) a second stage in which (a) an optical flow loss and (b) a Gram-matrix loss are minimized.

According to one or more embodiments, a system includes one or more processors to perform tokenization of visual input and reconstruction of visual output using one or more neural networks. The one or more neural networks include a tokenizer encoder having a wavelet transform block, configured to apply a wavelet transform to the visual input to generate a first intermediate wavelet domain representation, and one or more downsampling blocks, configured to obtain the intermediate wavelet domain representation of the visual input and generate a set of input tokens. The one or more neural networks also include a tokenizer decoder having one or more upsampling blocks, configured to obtain a set of output tokens and generate a second intermediate wavelet domain representation, and an inverse wavelet transform block, configured to apply an inverse wavelet transform to the second intermediate wavelet domain representation to generate the visual output. The system additionally includes one or more memories to store parameters associated with the one or more neural networks.

According to an embodiment of the system, the one or more neural networks further include a generative AI model configured to process the set of input tokens to generate the set of output tokens.

According to an embodiment of the system, at least one of the one or more downsampling blocks includes a causal spatio-temporal attention layer, and at least one of the one or more upsampling blocks includes a causal spatio-temporal attention layer.

According to an embodiment of the system, the wavelet transform block is configured to apply a Haar wavelet transform to the visual input, and the inverse wavelet transform block is configured to apply an inverse Haar wavelet transform to the second intermediate wavelet domain representation.

According to an embodiment of the system, at least one of the one or more downsampling blocks comprises a causal residual subblock, a causal downsampling subblock, and a causal spatio-temporal attention subblock.

According to an embodiment of the system, at least one of the one or more upsampling blocks comprises a causal residual subblock, a causal upsampling subblock, and a causal spatio-temporal attention subblock.

According to an embodiment of the system, the tokenizer encoder and the tokenizer decoder are trained via an end-to-end learning process, the end-to-end learning process that includes tokenizing, by the tokenizer encoder, sample visual input, reconstructing, by the tokenizer decoder, tokenized sample visual input, computing, by comparing the sample visual input with the reconstructed tokenized sample visual input, a model loss, and updating, based on gradients of the model loss, parameters associated with the tokenizer encoder and parameters associated with the tokenizer decoder. In at least one embodiment, the end-to-end learning process is a multi-stage learning process in which, during a first stage of the multi-stage learning process, a first loss function is used to compute the model loss, and in which, during a second stage of the multi-stage learning process, a second loss function is used to compute the model loss. In at least one embodiment, the first loss function is a combination loss function comprising (i) an L1 loss term that minimizes a pixel-wise RGB difference between the training image/video and the reconstruction thereof and (ii) a perceptual loss term and/or the second loss function is a combination loss function comprising (i) an optical flow (OF) loss and (ii) a Gram-matrix (GM) loss. In at least one embodiment, during a fine-tuning stage of the multi-stage learning process, an adversarial loss function is used to compute the model loss.

According to one or more embodiments, a method is provided for tokenizing visual input. The method includes obtaining visual input provided in a pixel space, applying a wavelet transform to the visual input to transform the visual input from the pixel space to a wavelet domain, thereby generating an intermediate wavelet domain representation of the visual input, and encoding the intermediate wavelet domain representation of the visual input to generate a plurality of tokens, each token being an embedding in a latent feature space.

According to an embodiment of the method, applying the wavelet transform to the visual input and/or the encoding the intermediate wavelet domain representation provides a spatial compression factor and a temporal compression factor.

According to an embodiment of the method, the plurality of tokens are continuous tokens or discrete tokens.

According to an embodiment, the method further includes processing, by a generative AI model, the plurality of tokens to generate a plurality of output tokens, each output token being an embedding in the latent feature space.

According to an embodiment, the method further includes decoding the plurality of output tokens to generate a wavelet domain representation of AI model output and applying an inverse wavelet transform to the wavelet domain representation of the AI model output to generate a pixel-space representation of the AI model output.

According to an embodiment of the method, applying the wavelet transform to the visual input and encoding the intermediate wavelet domain representation of the visual input are performed by a tokenizer encoder. In at least one embodiment, the tokenizer encoder includes a wavelet transform block, configured to apply a wavelet transform to the visual input to generate a first intermediate wavelet domain representation, and one or more downsampling blocks, configured to obtain the intermediate wavelet domain representation of the visual input and generate a set of input tokens. In at least one embodiment, at least one of the one or more downsampling blocks comprises a causal residual subblock, a causal downsampling subblock, and a causal spatio-temporal attention subblock.

According to an embodiment of the method, applying the wavelet transform to the visual input and encoding the intermediate wavelet domain representation of the visual input are performed by a tokenizer encoder, and decoding the plurality of output tokens and applying the inverse wavelet transform to the wavelet domain representation of the AI model output are performed by a tokenizer decoder. In at least one embodiment, the tokenizer encoder includes a wavelet transform block, configured to apply a wavelet transform to the visual input to generate a first intermediate wavelet domain representation, and one or more downsampling blocks, configured to obtain the intermediate wavelet domain representation of the visual input and generate a set of input tokens, and the tokenizer decoder includes one or more upsampling blocks, configured to obtain a set of output tokens and generate a second intermediate wavelet domain representation, and an inverse wavelet transform block, configured to apply an inverse wavelet transform to the second intermediate wavelet domain representation to generate visual output. In at least one embodiment, at least one of the one or more downsampling blocks includes a causal residual subblock, a causal downsampling subblock, and a causal spatio-temporal attention subblock, and at least one of the one or more upsampling blocks includes a causal residual subblock, a causal upsampling subblock, and a causal spatio-temporal attention subblock.

According to an embodiment of the method, the tokenizer encoder and the tokenizer decoder are trained via an end-to-end learning process that includes tokenizing, by the tokenizer encoder, sample visual input, reconstructing, by the tokenizer decoder, tokenized sample visual input, computing, by comparing the sample visual input with the reconstructed tokenized sample visual input, a model loss, and updating, based on gradients of the model loss, parameters associated with the tokenizer encoder and parameters associated with the tokenizer decoder. In at least one embodiment, the end-to-end learning process is a multi-stage learning process in which, during a first stage of the multi-stage learning process, a first loss function is used to compute the model loss, and during a second stage of the multi-stage learning process, a second loss function is used to compute the model loss.

According to one or more embodiments, non-transitory computer-readable media is provided having stored thereon executable instructions that, when executed by processing circuitry, cause the processing circuitry to perform the method for tokenizing visual input and any embodiment thereof.

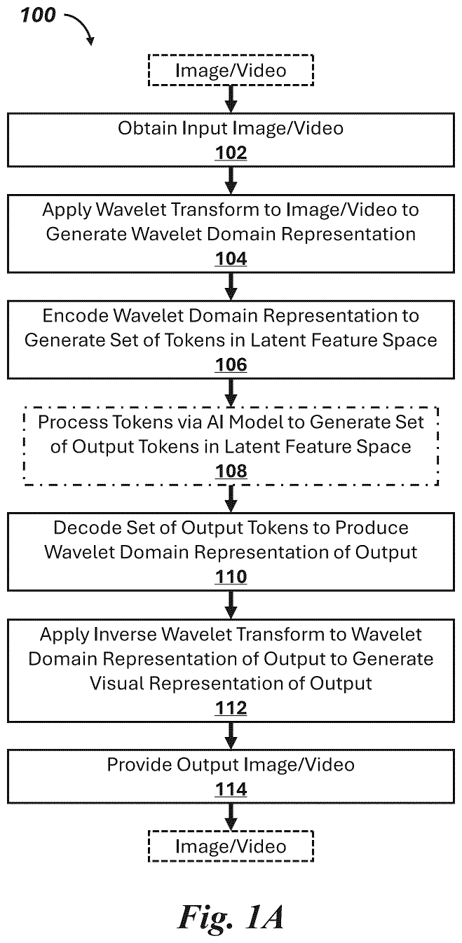

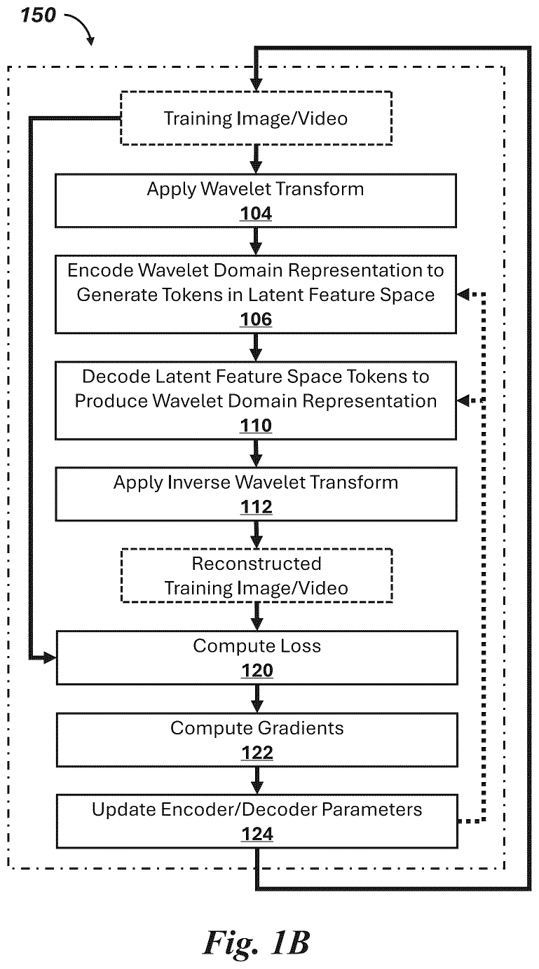

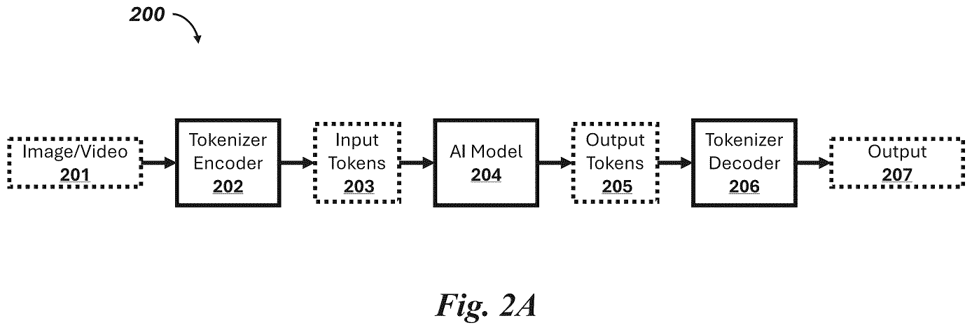

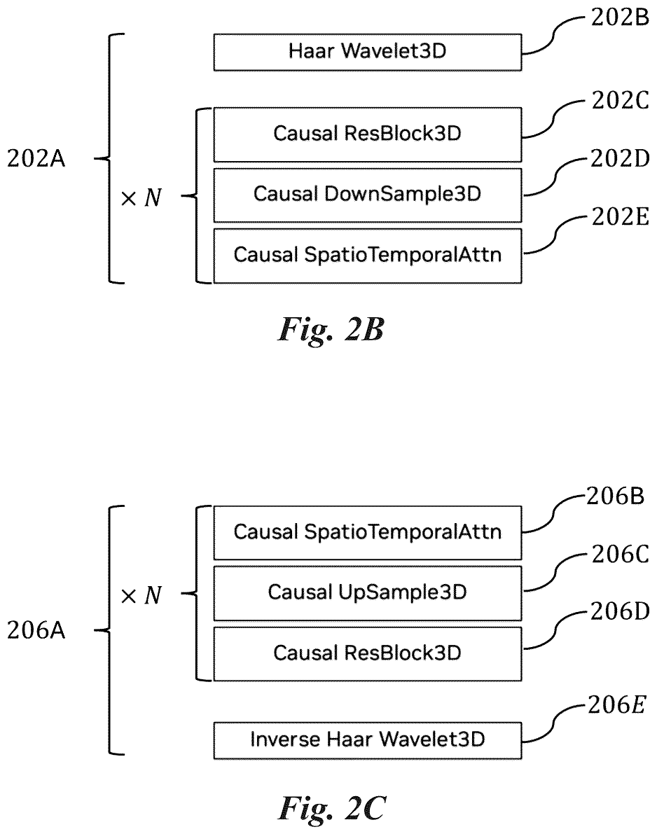

FIG. 1A is a flow diagram illustrating a method 100 for tokenizing visual input to provide a compact representation thereof and for de-tokenizing output tokens to provide a pixel-space representation thereof, in accordance with an embodiment. Each block of method 100, described herein, comprises a computing process that may be performed using any combination of hardware, firmware, and/or software. For instance, various functions may be carried out by a processor executing instructions stored in memory. Method 100 may also be embodied as computer-usable instructions stored on computer storage media. Method 100 may be provided by a standalone application, a service or hosted service (standalone or in combination with another hosted service), or a plug-in to another product, to name a few. In addition, method 100 is described, by way of example, with respect to the system of FIG. 2A. However, this method may additionally or alternatively be executed by any one system, or any combination of systems, including, but not limited to, those described herein. Furthermore, persons of ordinary skill in the art will understand that any system that performs method 100 is within the scope and spirit of embodiments of the present disclosure.

Method 100 obtains raw visual input provided, e.g., in the form of an image or in the form of a video and tokenizes the obtained raw visual input to provide a compact representation thereof. Method 100 additionally de-tokenizes output tokens, e.g., produced by an AI model (e.g., a generative diffusion model or an autoregressive transformer model) to provide a pixel-space representation of said output tokens.

At 102, method 100 receives/obtains an input image/video. In at least one embodiment, the input image/video is an input image/video x_{0:T}∈ [symbol] ^{(1+T)×H×W×3}, with H, W, T being the height, width, and one less than the total number of frames. This formulation is suitable for representing both images (i.e., T=0) and videos (i.e., T≥1), and facilitates tokenization of both images and videos using a single unified network architecture.

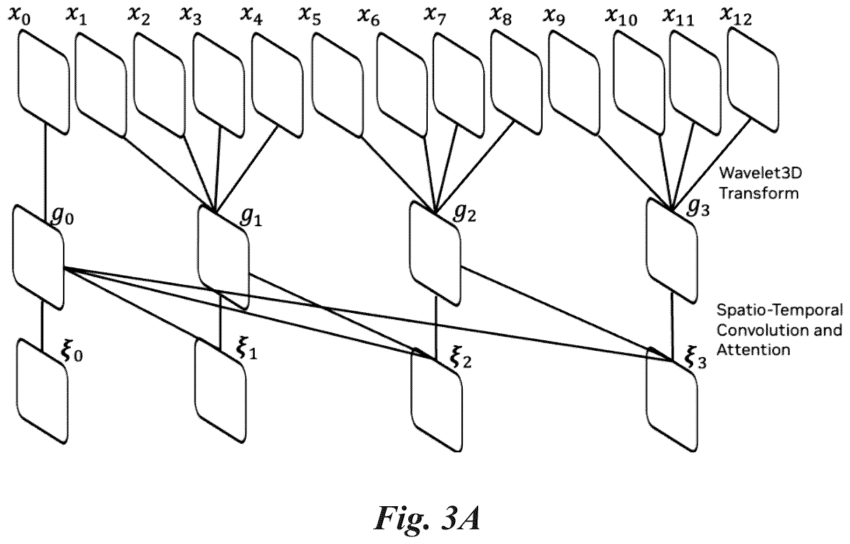

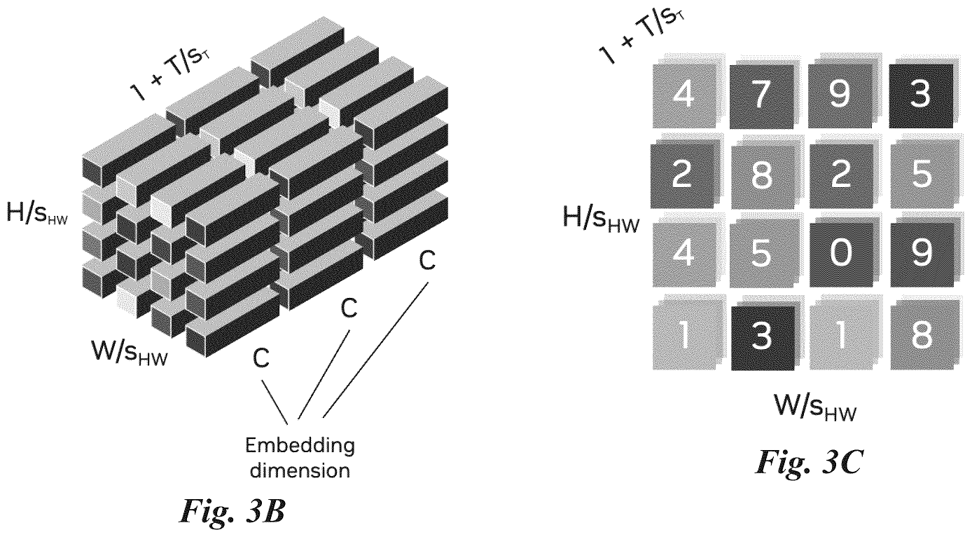

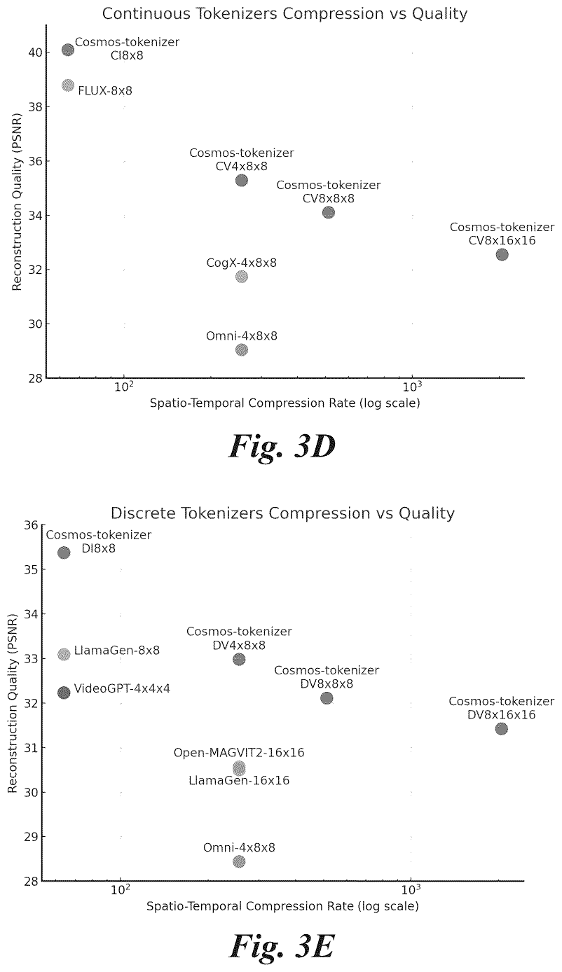

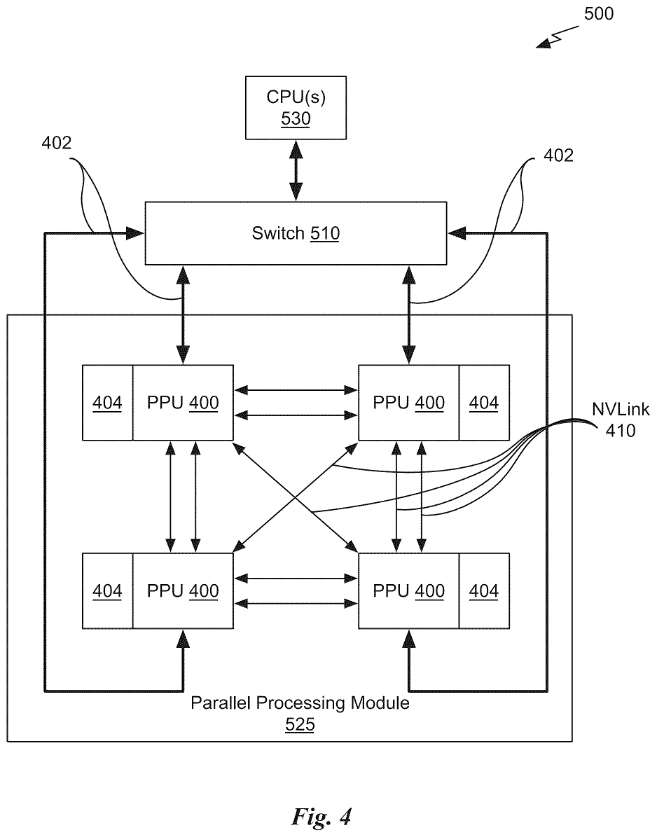

At 104, method 100 applies a wavelet transform to the input image/video to generate a wavelet space representation of the input image/video. In at least one embodiment, method 100 applies a Haar wavelet transform to the input image/video to generate the wavelet space representation. In at least one embodiment, method 100 applies a wavelet transform that transforms video input in a group-wise manner to downsample the video in the temporal dimension, e.g., by a factor of 4 or a factor of 8. In at least one embodiment, a wavelet transform is applied to groups (e.g., g₀, . . . , g₃) of frames of video input (e.g., x₀, . . . , x₁₂) as illustrated in FIG. 3A. In at least one embodiment, applying the wavelet transform to an input video provides spatio-temporal compression, transforming each pixel block (i.e. pixel patches corresponding to a patch_size of the wavelet transform, e.g., 4×4 pixel patches or 8×8 pixel patches, across groups of, e.g., 4 frames or 8 frames) into a single wavelet representation. Applying the wavelet transform at 104 thereby provides a spatial compression factor of

$${s}_{HW} = \frac{H}{{H}^{′}} = \frac{W}{{W}^{′}}$$

and a temporal compression factor of

$${s}_{T} = \frac{T}{{T}^{′}} .$$

For example, applying, at 104, a wavelet transform that provides a spatial compression factor of s_{HW}=8 and a temporal compression factor of s_{T}=8 to a 17-frame video with 224×224 pixels (each with channels R, G, and B) yields a wavelet space representation for each of 28×28×3 pixel blocks (corresponding to spatial

$$( \frac{H}{{s}_{HW}} \times \frac{W}{{s}_{HW}} ) and temporal ( 1 + \frac{T}{{s}_{T}} )$$

compression).

At 106, method 100 encodes the wavelet space representations to generate a set of tokens in a latent feature space that can be processed by an AI model. In at least one embodiment, the set of tokens are continuous tokens, i.e., provided in the form of continuous latent embeddings with an embedding dimension of C. In at least one embodiment, the set of tokens are continuous tokens represented along spatial and temporal dimensions as illustrated in FIG. 3B. In at least one embodiment, the set of tokens are discrete tokens that provide a discrete value for each of a plurality of latent dimensions, thereby mapping each token to a vocabulary. In at least one embodiment, the set of tokens are discrete tokens represented along spatial and temporal dimensions as illustrated in FIG. 3C. The choice of continuous tokens or discrete tokens is made based on the characteristics of an AI model that has been chosen to process (i.e. at 108) the generated tokens. In at least one embodiment, the AI model is a diffusion model and the tokens are continuous tokens. In at least one embodiment, the AI model is an autoregressive transformer model and the tokens are discrete tokens. In at least one embodiment, the encoding at 106 yields a token image/video z_{0:T′}∈ [symbol] ^{(1+T′)×H′×w′×C}, with a spatial compression factor of

$${s}_{HW} = \frac{H}{{H}^{′}} = \frac{W}{{W}^{′}}$$

and a temporal compression factor of

$${s}_{T} = \frac{T}{{T}^{′}} .$$

In at least one embodiment, the encoding at 106 employs causal temporal convolution layers and causal temporal attention layers to preserve the natural temporal order of video frames, ensuring seamless tokenization thereof images. In at least one embodiment, the causal temporal convolution layers perform factorized convolution, e.g., in which a 2D spatial downsampling convolution is followed by a 1D temporal downsampling convolution, and/or the causal temporal attention layers perform factorized attention, e.g., in which a 2D spatial attention operation is followed by a 1D temporal attention operation.

At 108, the AI model processes the set of tokens generated at 106 to generate a set of output tokens, and at 110, method 100 decodes a set of output tokens to produce a wavelet domain representation of the output of the AI model. In at least one embodiment, the decoding at 110 employs causal temporal convolution layers and causal temporal attention layers to preserve the natural temporal order of video frames, and in at least one embodiment, the causal temporal convolution layers perform factorized convolution (e.g., in which a 2D spatial downsampling convolution is followed by a 1D temporal downsampling convolution) and/or the causal temporal attention layers perform factorized attention (e.g., in which a 2D spatial attention operation is followed by a 1D temporal attention operation). At 112, method 100 applies an inverse wavelet transform to the wavelet domain representation of the output of the AI model to generate a pixel space representation of the output of the AI model—e.g., an image or a video. In at least one embodiment, the set of output tokens provide an output token image/video y_{0:T′}∈ [symbol] ^{(1+T′)×H′×W′×C}, and the combination of the decoding at 110 and the application of the inverse wavelet transform at 112 yields an output image/video w_{0:T}∈ [symbol] ^{(1+T)×H×W×3}.

FIG. 1B is a flow diagram illustrating a method 150 for training a visual tokenizer to tokenize visual input and to de-tokenize output tokens to provide a pixel-space representation thereof, in accordance with an embodiment. Each block of method 150, described herein, comprises a computing process that may be performed using any combination of hardware, firmware, and/or software. For instance, various functions may be carried out by a processor executing instructions stored in memory. Method 150 may also be embodied as computer-usable instructions stored on computer storage media. Method 150 may be provided by a standalone application, a service or hosted service (standalone or in combination with another hosted service), or a plug-in to another product, to name a few. In addition, method 150 is described, by way of example, with respect to the system of FIG. 2A. However, this method may additionally or alternatively be executed by any one system, or any combination of systems, including, but not limited to, those described herein. Furthermore, persons of ordinary skill in the art will understand that any system that performs Method 150 is within the scope and spirit of embodiments of the present disclosure.

Stages 104, 106, 110, and 112 of method 150 are identical to equivalently numbered stages of method 100. However, in method 150, the input to stage 104 is a training image/video, the input and output tokens are identical (as there is no processing performed by an AI model, as at stage 108 of method 100), and the output of stage 112 is a reconstruction of the training image/video (as opposed to a reconstruction of a token image/video generated by an AI model). In at least one embodiment, the training image/video is an input training image/video x_{0:T}∈ [symbol] ^{(1+T)×H×W×3}, the encoding at 106 yields a token image/video z_{0:T′}∈ [symbol] ^{(1+T′)×H′×W′×C}, and the output of 112 is a reconstructed training image/video \hat{x}_{0:T}∈ [symbol] ^{(1+T)×H×W×3}. In at least one embodiment, method 150 is performed to train a visual tokenizer to provide a compression rate of 8×8 or 16×16 for images (where the compression rates are expressed as H×W, H and W representing spatial dimensions). In at least one embodiment, method 150 is performed to train a visual tokenizer to provide a compression rate of 4×8×8, 8×8×8, or 8×16×16 for videos (where the compression rates are expressed as T×H×W, T representing the temporal dimension and H and W representing spatial dimensions).

At 120, method 150 computes a loss by comparing the training image/video with the reconstruction thereof. In at least one embodiment, method 150 is a two-stage training process that employs a first loss during a first stage and a second loss during a second stage. In at least one embodiment, the loss computed at 120 during the first stage is a combination of (i) an L1 loss that minimizes a pixel-wise RGB difference between the training image/video and the reconstruction thereof and (ii) a perceptual loss. In at least one embodiment, the L1 loss is:

$${ℒ}_{1} = {‖ {\hat{x}}_{0 : T} - {x}_{0 : T} ‖}_{1} .$$

In at least one embodiment, the perceptual loss is based on VGG-19 features. In at least one embodiment, the perceptual loss is:

$${ℒ}_{Perceptual} = \frac{1}{L} {\sum }_{l = 1}^{L} {\sum }_{t} {α}_{l} {‖ {VGG}_{l} ( {\hat{x}}_{t} ) - {VGG}_{l} ( {x}_{t} ) ‖}_{1} ,$$

where VGGₗ(⋅)∈ [symbol] ^{H×W×C} is the features from the l-th layer of a pre-trained VGG-19 network, L is the number of layers considered, and αₗ is the weight of the l-th layer.

In at least one embodiment, the loss computed at 120 during the second stage is a combination of (i) an optical flow (OF) loss (for enhancing temporal smoothness) and (ii) a Gram-matrix (GM) loss (for enhancing the sharpness of the reconstructed image). In at least one embodiment, the OF loss is:

$${ℒ}_{Flow} = \frac{1}{T} {\sum }_{t = 1}^{T} {‖ OF ( {\hat{x}}_{t} , {\hat{x}}_{t - 1} ) - OF ( {x}_{t} , {x}_{t - 1} ) ‖}_{1} + \frac{1}{T} {\sum }_{t = 0}^{T - 1} {‖ OF ( {\hat{x}}_{t} , {\hat{x}}_{t + 1} ) - OF ( {x}_{t} , {x}_{t + 1} ) ‖}_{1} .$$

In at least one embodiment, the GM loss is:

$${ℒ}_{Gram} = \frac{1}{L} {\sum }_{l = 1}^{L} {\sum }_{t} {α}_{l} {‖ {GM}_{l} ( {\hat{x}}_{t} ) - {GM}_{l} ( {x}_{t} ) ‖}_{1} .$$

In at least one embodiment, method 150 is a multi-stage training process that includes a fine-tuning stage. In at least one embodiment, the loss computed at 120 during the fine tuning stage is an adversarial loss. The adversarial loss enhances reconstruction details—particularly at large compression rates.

In at least one embodiment, method 150 is an end-to-end training process that jointly trains a tokenizer encoder and a tokenizer decoder based on a loss computed at 120 that considers only the final output of the tokenizer decoder and a ground truth image and does not consider any auxiliary losses, e.g., commitment or KL prior losses.

At 122, method 150 computes the gradients of the loss computed at 120 with respect to the parameters of the encoder and decoder used for stages 106 and 110. At 124, method 150 updates the parameters of the encoder and decoder based on the computed gradients. The process then repeats using a different training image/video. In at least one embodiment, the gradients computed at 122 are an average of gradients computed for each of a plurality of images/videos in a training batch.

In at least one embodiment, method 150 is repeated for a number of training steps, each training step including one or more iterations of a forward pass (which includes 104 through 112 and provides the reconstructed training image/video), a loss computation at 120, and a gradient computation at 122. In at least one embodiment, each training step corresponds to a batch of training samples, each training sample in the batch being processed via a single training iteration that includes the forward pass, loss computation, and gradient computation. During each training step of the process, a parameter update is performed at 124. In at least one embodiment, each training step corresponds to a batch of training samples processed via a plurality of training iterations and performing the parameter update at 124 is based on an average of gradients computed during each training iteration.

In at least one embodiment, method 150 is repeated for training batches of images and training batches of videos to facilitate learning of tokenization for both images and videos. In at least one embodiment, method 150 is performed iteratively with a variety of different image/video resolutions and a variety of different aspect ratios. In at least one embodiment, method 150 is performed iteratively with a variety of different image/video aspect ratios, which include 1:1, 3:4, 4:3, 9:16, and 16:9. In at least one embodiment, method 150 is performed iteratively with a variety of different video durations. As a result of performing method 150 iteratively with different video durations, a visual tokenizer is trained to be temporally length-agnostic during inference, and is capable of tokenizing beyond the temporal length with which training was performed.

In one or more embodiments, at least one of stages 104, 106, 110, 112, 120, 122, or 124 is performed on a server or in a data center to generate the task video, and the task video is streamed to a user device. In an embodiment, at least one of stages 104, 106, 110, 112, 120, 122, or 124 is performed within a cloud computing environment. In an embodiment, at least one of stages 104, 106, 110, 112, 120, 122, or 124 is performed for training, testing, or certifying a neural network employed in a machine, robot, or autonomous vehicle. In an embodiment, at least one of stages 104, 106, 110, 112, 120, 122, or 124 is performed on a virtual machine comprising a portion of a graphics processing unit. In an embodiment, at least one of stages 104, 106, 110, 112, 120, 122, or 124 is implemented to include advanced error correction, fault-tolerance, and self-healing capabilities.

FIG. 2A is a block diagram illustrating a system 200, in accordance with an embodiment, for tokenizing visual input to provide a compact representation thereof and for de-tokenizing output tokens to provide a pixel-space representation thereof. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the system 200 is within the scope and spirit of embodiments of the present disclosure.

The system 200 includes a tokenizer with an encoder-decoder architecture that includes a tokenizer encoder 202 and a tokenizer decoder 206. System 200 additionally includes an AI model 204, e.g., a diffusion model, an autoregressive transformer model, a video-LLM (VLLM), a vision transformer (ViT)), etc. System 200 obtains, as input, image/video 201. Tokenizer encoder 202 is configured to encode (i.e., compresses) the image/video 201 to generate a plurality of input tokens 203 that represent the image/video 201 in an intermediate latent feature space. AI model 204 is configured to obtain the plurality of input tokens 203 as input and process them to produce a plurality of output tokens 205. Tokenizer decoder 206 is configured to obtain the plurality of output tokens 205 as input and decode (i.e., decompress) them to generate output 207, which is provided, e.g., in the form of an image or a video.

Tokenizer encoder 202 is configured to (i) transform raw visual input (e.g., image/video 201) into a wavelet space to generate a wavelet space representation thereof and (ii) encode the wavelet space representation to generate the plurality of input tokens 203. Similarly, tokenizer decoder 206 is configured to (iii) decode the plurality of output tokens 205 to provide a wavelet space representation thereof and (iv) transform the wavelet space representation into a pixel space representation to provide the output 207. In at least one embodiment, tokenizer encoder 202 is configured as tokenizer encoder 202A of FIG. 2B. In at least one embodiment, tokenizer decoder 206 is configured as tokenizer decoder 206A of FIG. 2C.

In at least one embodiment, the raw visual input is an input image/video x_{0:T}∈ [symbol] ^{(1+T)×H×W×3}, with H, W, T being the height, width, and number of frames minus one, respectively, and tokenizer encoder 202 (the operation of which is represented by E) is configured to tokenize the input image/video x_{0:T} into a token image/video z_{0:T′}∈ [symbol] ^{(1+T′)×H′×W′×C}, with a spatial compression factor of

$${s}_{HW} = \frac{H}{{H}^{′}} = \frac{W}{{W}^{′}}$$

and a temporal compression factor of

$${s}_{T} = \frac{T}{{T}^{′}} .$$

During inference, tokenizer decoder 206 (the operation of which is represented by [symbol] ) is configured to process an output token image/video y_{0:T′}∈ [symbol] ^{(1+T′)×H′×W′×C} (e.g., a token image/video generated by AI model 204) to generate an output image/video w_{0:T}∈ [symbol] ^{(1+T)×H×W×3}. During training, tokenizer decoder 206 is configured to process the token image/video z_{0:T′} (generated by tokenizer encoder 202) to generate a reconstructed training image/video \hat{x}_{0:T}∈ [symbol] ^{(1+T)×H×W×3}, and the collective operation of the tokenizer encoder 202 and the tokenizer decoder 206 is represented by [symbol] (ε(x_{0:T}))=\hat{x}_{0:T}.

In at least one embodiment, each of tokenizer encoder 202 and tokenizer decoder 206 operate in a wavelet space and employ a temporally causal design, ensuring that each stage processes only current and past frames and is independent of future frames. In at least one embodiment, tokenizer encoder 202 includes a 2-level wavelet transform block that transforms the input image/video to a wavelet space while mapping the input video x_{0:T} in a group-wise manner to provide for downsampling the inputs along both spatial and temporal dimensions. In at least one embodiment, the groups are formed as: {x₀, x_{1:4}>x_{5:8}, . . . , x_{(T-3):T}}→{g₀, g₁, g₂, . . . , g_{T/4}} as illustrated in FIG. 3A. Providing a wavelet transform allows subsequent blocks of the tokenizer encoder 202 to operate on a more compact video representation from which pixel information redundancies have been eliminated, thereby allowing those subsequent blocks to focus on semantic compression. Providing the wavelet improves compression-quality trade-off and decreases runtime and, in combination with other aspects of system 200, yields further improvements to compression-quality trade off and runtime.

In at least one embodiment, subsequent blocks of tokenizer encoder 202 process the wavelet space representations in a temporally causal manner as {g₀, g_{0:1}, g_{0:2}, . . . }→{ξ₀, ξ₁, ξ₂, . . . }—as also illustrated in FIG. 3A. Providing for temporal causality ensures compatibility with AI models developed for applications that operate in a temporally causal setting, e.g., physical AI applications. The decoder mirrors the encoder, replacing temporally causal downsampling blocks with temporally causal upsampling blocks (which operate in the wavelet domain) and providing a 2-level inverse wavelet transform block that transforms a wavelet space representation of output to a pixel space. In this manner, the encoder-decoder leverages wavelet transforms and causal operations to capture spatial and temporal dependencies in the data (i.e., an input image/video).

FIG. 2B is a block diagram illustrating a tokenizer encoder 202A, in accordance with an embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the tokenizer encoder 202A is within the scope and spirit of embodiments of the present disclosure.

In the embodiment illustrated in FIG. 2B, tokenizer encoder 202A includes a Haar wavelet transform block 202B configured to receive raw visual input (e.g., image/video 201) and apply a Haar wavelet transform thereto, thus providing a wavelet space representation. Tokenizer encoder 202A further includes a plurality of N downsampling encoder blocks, each including a causal residual subblock 202C, a causal downsampling subblock 202D, and a causal spatio-temporal attention subblock 202E. The N downsampling encoder blocks encode the wavelet space representation of the raw visual input into the plurality of input tokens 203.

In at least one embodiment, each of the N downsampling encoder blocks employs a spatio-temporal factorized 3D convolution, first applying a 2D convolution with a kernel size of 1×k×k to capture spatial information, followed by a temporal convolution with a kernel size of k×1×1 to capture temporal dynamics. To ensure causality, left padding of k−1 is utilized, and to capture long-range dependencies, a spatio-temporal factorized causal self-attention is utilized with a global support region—e.g., 1+T′ for the last encoder block. The utilization of factorized convolution and factorized attention in combination with a wavelet transform (e.g., as provided by system 200) yields compression-quality trade-off improvements—resulting in higher-quality visual output—while also decreasing runtime. In at least one embodiment, the Swish activation function is used for non-linearity. In at least one embodiment, Layer Normalization (LayerNorm) is utilized instead of Group Normalization (GroupNorm), thereby preventing large magnitudes from appearing in specific regions of the latent space or reconstructed outputs.

FIG. 2C is a block diagram illustrating a tokenizer decoder 206A, in accordance with an embodiment. It should be understood that this and other arrangements described herein are set forth only as examples. Other arrangements and elements (e.g., machines, interfaces, functions, orders, groupings of functions, etc.) may be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory. Furthermore, persons of ordinary skill in the art will understand that any system that performs the operations of the tokenizer decoder 206A is within the scope and spirit of embodiments of the present disclosure.

Tokenizer decoder 206A includes a plurality of N upsampling decoder blocks, each including a causal spatio-temporal attention subblock 206B, a causal upsampling subblock 206C, and a causal residual subblock 206D. The N upsampling decoder blocks decode the plurality of output tokens 205 to produce a wavelet space output representation. Tokenizer decoder 206A additionally includes an inverse Haar wavelet transform block 206E configured to receive the wavelet space output representation and apply an inverse Haar wavelet transform thereto, thus providing pixel space output representation (e.g., output 207 in the form of an image/video).

The decoder mirrors the encoder, replacing the downsampling blocks with an upsampling block. In at least one embodiment, each of the N upsampling decoder blocks employs a spatio-temporal factorized 3D convolution, first applying a 2D convolution with a kernel size of 1×k×k to capture spatial information, followed by a temporal convolution with a kernel size of k×1×1 to capture temporal dynamics. To ensure causality, left padding of k−1 is utilized, and to capture long-range dependencies, a spatio-temporal factorized causal self-attention is utilized with a global support region—e.g., 1+T′ for the first decoder block. In at least one embodiment, the Swish activation function is used for non-linearity. In at least one embodiment, Layer Normalization (LayerNorm) is utilized instead of Group Normalization (GroupNorm), thereby preventing large magnitudes from appearing in specific regions of the latent space or reconstructed outputs.

FIG. 3A illustrates a temporal causality mechanism, in accordance with an embodiment, where input video frames x₀, x₁, . . . , x₁₂ are processed through grouped intermediate outputs g₀, g₁, . . . , and further refined by spatio-temporal convolution and attention operations. In FIG. 3A, frames of an input video x_{0:T} are grouped to downsample the inputs by a factor of four along x, y, and t. In at least one embodiment, the groups are formed as: {x₀, x_{1:4}, x_{5:8}, . . . , x_{(T-3):T}}→{g₀, g₁, g₂, . . . , g_{T/4}}. Thereafter, wavelet space representations of the groups of frames are processed in a temporally causal manner, forming output tokens as {g₀, g_{0:1}, g_{0:2}, . . . }→{ξ₀, ξ₁, ξ₂, . . . }.

FIG. 3B provides a visualization of continuous tokens, and FIG. 3C provides a visualization of discrete tokens. Both the continuous tokens of FIG. 3B and the discrete tokens of FIG. 3C provide for compression along spatial

$$( \frac{H}{{s}_{HW}} \times \frac{W}{{s}_{HW}} ) and temporal ( 1 + \frac{T}{{s}_{T}} )$$

dimensions, with a spatial compression factor of s_{HW} and a temporal compression factor of s_{T}. The first temporal token represents the first input frame, enabling joint image (T=0) and video (T>0) tokenization in a shared latent space. The continuous tokens of FIG. 3B are latent embeddings with an embedding size of C, while the discrete tokens of FIG. 3C are quantized indices, each index (e.g., 1, 2, 3, 4, . . . ) representing a discrete latent code. In at least one embodiment, a vanilla autoencoder (AE) formulation is utilized to model the latent space of the continuous tokens of FIG. 3B. In at least one embodiment, the latent dimension of the continuous tokens is 16. In at least one embodiment, Finite-Scalar-Quantization (FSQ) is utilized as a latent space quantizer for the discrete tokens of FIG. 3C. In at least one embodiment, the latent dimension of the discrete tokens is 6, which represents a number of the FSQ levels, which are (8,8,8,5,5,5)—which corresponds to a vocabulary size of 64,000.

FIG. 3D plots reconstruction quality versus spatio-temporal compression rate for a variety of different continuous tokenizers, including a continuous tokenizer according to an embodiment of the present disclosure (i.e., “Cosmos-tokenizer”). FIG. 3E plots reconstruction quality versus spatio-temporal compression rate for a variety of different discrete tokenizers, including a discrete tokenizer according to an embodiment of the present disclosure (i.e., “Cosmos-Tokenizer”). FIGS. 3D and 3E measure reconstruction quality as peak signal to noise ratio (PSNR) and plot spatio-temporal compression on a log scale. The evaluation was performed on the DAVIS dataset. The PSNR of image tokenizers is calculated on all individual frames. Each solid point represents a tokenizer configuration, illustrating the trade-off between compression rate and quality. Notably, the tokenizers according to embodiments of the present disclosure demonstrate exceptional compression-quality trade-off, delivering superior quality even at higher compression rates when compared to other tokenizers.

As shown in FIGS. 3D and 3E, the tokenizers according to embodiments of the present disclosure significantly outperform existing tokenizers by a large margin, achieving, e.g., +4 dB PSNR improvement in reconstruction quality on DAVIS videos. Furthermore, the tokenizers according to embodiments of the present disclosure run up to 12×faster and demonstrated the ability to encode videos up to 8 seconds at 1080 p and 10 seconds at 720 p in one shot without running out of memory on a single NVIDIA A100 GPU with 80 GB memory.

More illustrative information will now be set forth regarding various optional architectures and features with which the foregoing systems and methods may be implemented, in accordance with embodiments. It should be strongly noted that the following information is set forth for illustrative purposes and should not be construed as limiting in any manner. Any of the following features may be optionally incorporated with or without the exclusion of other features described.

### Exemplary Computing System

Systems with multiple GPUs and CPUs are used in a variety of industries as developers expose and leverage more parallelism in applications such as artificial intelligence computing. High-performance GPU-accelerated systems with tens to many thousands of compute nodes are deployed in data centers, research facilities, and supercomputers to solve ever larger problems. As the number of processing devices within the high-performance systems increases, the communication and data transfer mechanisms need to scale to support the increased bandwidth.

FIG. 4 is a conceptual diagram of a processing system 500 implemented using multiple PPUs 400, in accordance with an embodiment. The exemplary system 500 may utilized as a particular node—or portion thereof—in the above-described multi-node computing systems. In addition to the multiple PPUs 400, the processing system 500 includes a CPU 530, switch 510, and respective memories 404 for the PPUs 400.

Each parallel processing unit (PPU) 400 may include hundreds or thousands of cores that are capable of handling hundreds or thousands of software threads simultaneously. The PPUs 400 may generate pixel data for output images in response to rendering commands (e.g., rendering commands from the CPU(s) 530 received via a host interface). The PPUs 400 may include graphics memory, such as display memory, for storing pixel data or any other suitable data, such as GPU data. The display memory may be included as part of the memory 404. The PPUs 400 may include two or more GPUs operating in parallel (e.g., via a link). The link may directly connect the GPUs (e.g., using NVLINK 410) or may connect the GPUs through a switch (e.g., using switch 510). When combined together, each PPU 400 may generate pixel data or GPGPU data for different portions of an output or for different outputs (e.g., a first PPU for a first image and a second PPU for a second image). Each PPU 400 may include its own memory 404, or may share memory with other PPUs 400.

The PPUs 400 may each include, and/or be configured to perform functions of, one or more processing cores and/or components thereof, such as Tensor Cores (TCs), Tensor Processing Units (TPUs), Pixel Visual Cores (PVCs), Vision Processing Units (VPUs), Graphics Processing Clusters (GPCs), Texture Processing Clusters (TPCs), Streaming Multiprocessors (SMs), Tree Traversal Units (TTUs), Artificial Intelligence Accelerators (AIAs), Deep Learning Accelerators (DLAs), Arithmetic-Logic Units (ALUs), Application-Specific Integrated Circuits (ASICs), Floating Point Units (FPUs), input/output (I/O) elements, peripheral component interconnect (PCI) or peripheral component interconnect express (PCIe) elements, and/or the like.

The NVLink 410 provides high-speed communication links between each of the PPUs 400. Although a particular number of NVLink 410 and interconnect 402 connections are illustrated in FIG. 4, the number of connections to each PPU 400 and the CPU 530 may vary. The switch 510 interfaces between the interconnect 402 and the CPU 530. The PPUs 400, memories 404, and NVLinks 410 may be situated on a single semiconductor platform to form a parallel processing module 525. In an embodiment, the switch 510 supports two or more protocols to interface between various different connections and/or links.

In another embodiment (not shown), the NVLink 410 provides one or more high-speed communication links between each of the PPUs 400 and the CPU 530 and the switch 510 interfaces between the interconnect 402 and each of the PPUs 400. The PPUs 400, memories 404, and interconnect 402 may be situated on a single semiconductor platform to form a parallel processing module 525. In yet another embodiment (not shown), the interconnect 402 provides one or more communication links between each of the PPUs 400 and the CPU 530 and the switch 510 interfaces between each of the PPUs 400 using the NVLink 410 to provide one or more high-speed communication links between the PPUs 400. In another embodiment (not shown), the NVLink 410 provides one or more high-speed communication links between the PPUs 400 and the CPU 530 through the switch 510. In yet another embodiment (not shown), the interconnect 402 provides one or more communication links between each of the PPUs 400 directly. One or more of the NVLink 410 high-speed communication links may be implemented as a physical NVLink interconnect or either an on-chip or on-die interconnect using the same protocol as the NVLink 410.

In the context of the present description, a single semiconductor platform may refer to a sole unitary semiconductor-based integrated circuit fabricated on a die or chip. It should be noted that the term single semiconductor platform may also refer to multi-chip modules with increased connectivity which simulate on-chip operation and make substantial improvements over utilizing a conventional bus implementation. Of course, the various circuits or devices may also be situated separately or in various combinations of semiconductor platforms per the desires of the user. Alternately, the parallel processing module 525 may be implemented as a circuit board substrate and each of the PPUs 400 and/or memories 404 may be packaged devices. In an embodiment, the CPU 530, switch 510, and the parallel processing module 525 are situated on a single semiconductor platform.

In an embodiment, the signaling rate of each NVLink 410 is 20 to 25 Gigabits/second and each PPU 400 includes six NVLink 410 interfaces (as shown in FIG. 4, five NVLink 410 interfaces are included for each PPU 400). Each NVLink 410 provides a data transfer rate of 25 Gigabytes/second in each direction, with six links providing 400 Gigabytes/second. The NVLinks 410 can be used exclusively for PPU-to-PPU communication as shown in FIG. 4, or some combination of PPU-to-PPU and PPU-to-CPU, when the CPU 530 also includes one or more NVLink 410 interfaces.

In an embodiment, the NVLink 410 allows direct load/store/atomic access from the CPU 530 to each PPU's 400 memory 404. In an embodiment, the NVLink 410 supports coherency operations, allowing data read from the memories 404 to be stored in the cache hierarchy of the CPU 530, reducing cache access latency for the CPU 530. In an embodiment, the NVLink 410 includes support for Address Translation Services (ATS), allowing the PPU 400 to directly access page tables within the CPU 530. One or more of the NVLinks 410 may also be configured to operate in a low-power mode.

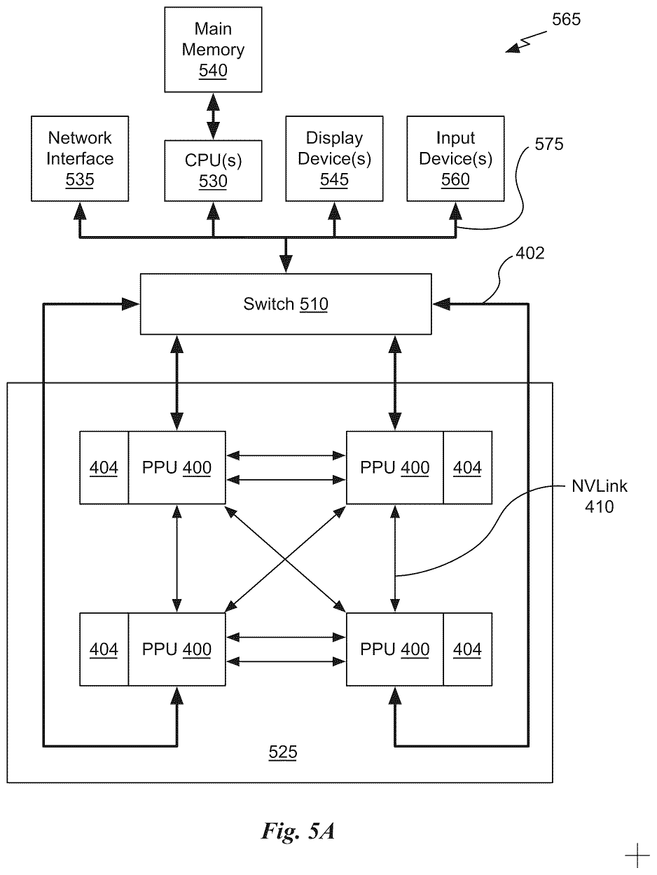

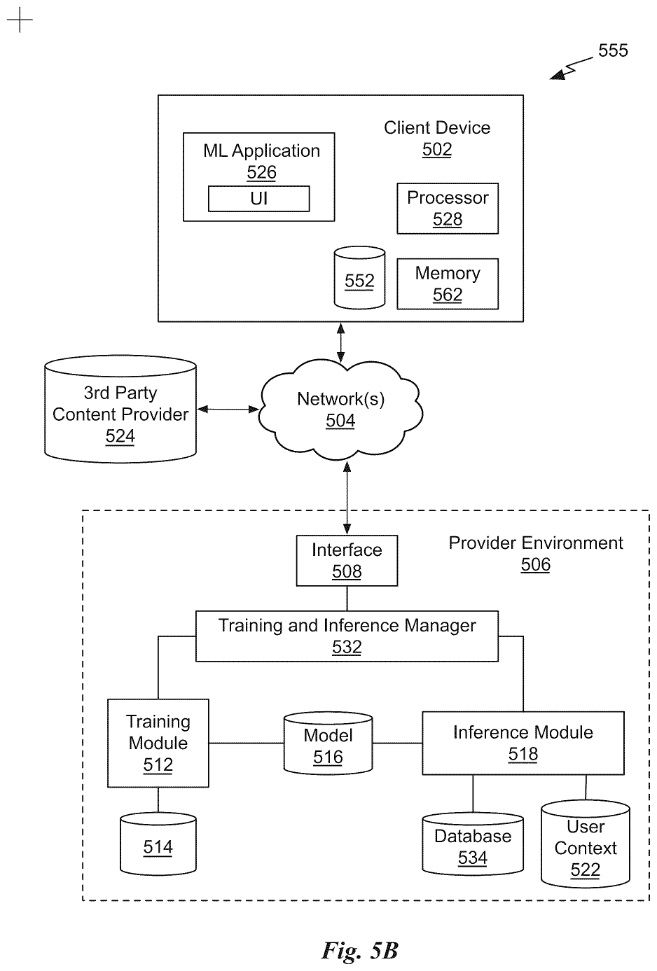

FIG. 5A illustrates an exemplary system 565 in which the various architecture and/or functionality of the various previous embodiments may be implemented. The exemplary system 565 may be configured to implement the method 300 shown in FIG. 3.

As shown, a system 565 is provided including at least one central processing unit 530 that is connected to a communication bus 575. The communication bus 575 may directly or indirectly couple one or more of the following devices: main memory 540, network interface 535, CPU(s) 530, display device(s) 545, input device(s) 560, switch 510, and parallel processing system 525. The communication bus 575 may be implemented using any suitable protocol and may represent one or more links or busses, such as an address bus, a data bus, a control bus, or a combination thereof. The communication bus 575 may include one or more bus or link types, such as an industry standard architecture (ISA) bus, an extended industry standard architecture (EISA) bus, a video electronics standards association (VESA) bus, a peripheral component interconnect (PCI) bus, a peripheral component interconnect express (PCIe) bus, HyperTransport, and/or another type of bus or link. In some embodiments, there are direct connections between components. As an example, the CPU(s) 530 may be directly connected to the main memory 540. Further, the CPU(s) 530 may be directly connected to the parallel processing system 525. Where there is direct, or point-to-point connection between components, the communication bus 575 may include a PCIe link to carry out the connection. In these examples, a PCI bus need not be included in the system 565.

Although the various blocks of FIG. 5A are shown as connected via the communication bus 575 with lines, this is not intended to be limiting and is for clarity only. For example, in some embodiments, a presentation component, such as display device(s) 545, may be considered an I/O component, such as input device(s) 560 (e.g., if the display is a touch screen). As another example, the CPU(s) 530 and/or parallel processing system 525 may include memory (e.g., the main memory 540 may be representative of a storage device in addition to the parallel processing system 525, the CPUs 530, and/or other components). In other words, the computing device of FIG. 5A is merely illustrative. Distinction is not made between such categories as “workstation,” “server,” “laptop,” “desktop,” “tablet,” “client device,” “mobile device,” “hand-held device,” “game console,” “electronic control unit (ECU),” “virtual reality system,” and/or other device or system types, as all are contemplated within the scope of the computing device of FIG. 5A.

The system 565 also includes a main memory 540. Control logic (software) and data are stored in the main memory 540 which may take the form of a variety of computer-readable media. The computer-readable media may be any available media that may be accessed by the system 565. The computer-readable media may include both volatile and nonvolatile media, and removable and non-removable media. By way of example, and not limitation, the computer-readable media may comprise computer-storage media and communication media.

The computer-storage media may include both volatile and nonvolatile media and/or removable and non-removable media implemented in any method or technology for storage of information such as computer-readable instructions, data structures, program modules, and/or other data types. For example, the main memory 540 may store computer-readable instructions (e.g., that represent a program(s) and/or a program element(s), such as an operating system. Computer-storage media may include, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which may be used to store the desired information and which may be accessed by system 565. As used herein, computer storage media does not comprise signals per se.

The computer storage media may embody computer-readable instructions, data structures, program modules, and/or other data types in a modulated data signal such as a carrier wave or other transport mechanism and includes any information delivery media. The term “modulated data signal” may refer to a signal that has one or more of its characteristics set or changed in such a manner as to encode information in the signal. By way of example, and not limitation, the computer storage media may include wired media such as a wired network or direct-wired connection, and wireless media such as acoustic, RF, infrared and other wireless media. Combinations of any of the above should also be included within the scope of computer-readable media.

Computer programs, when executed, enable the system 565 to perform various functions. The CPU(s) 530 may be configured to execute at least some of the computer-readable instructions to control one or more components of the system 565 to perform one or more of the methods and/or processes described herein. The CPU(s) 530 may each include one or more cores (e.g., one, two, four, eight, twenty-eight, seventy-two, etc.) that are capable of handling a multitude of software threads simultaneously. The CPU(s) 530 may include any type of processor, and may include different types of processors depending on the type of system 565 implemented (e.g., processors with fewer cores for mobile devices and processors with more cores for servers). For example, depending on the type of system 565, the processor may be an Advanced RISC Machines (ARM) processor implemented using Reduced Instruction Set Computing (RISC) or an x86 processor implemented using Complex Instruction Set Computing (CISC). The system 565 may include one or more CPUs 530 in addition to one or more microprocessors or supplementary co-processors, such as math co-processors.

In addition to or alternatively from the CPU(s) 530, the parallel processing module 525 may be configured to execute at least some of the computer-readable instructions to control one or more components of the system 565 to perform one or more of the methods and/or processes described herein. The parallel processing module 525 may be used by the system 565 to render graphics (e.g., 3D graphics) or perform general purpose computations. For example, the parallel processing module 525 may be used for General-Purpose computing on GPUs (GPGPU). In embodiments, the CPU(s) 530 and/or the parallel processing module 525 may discretely or jointly perform any combination of the methods, processes and/or portions thereof.

The system 565 also includes input device(s) 560, the parallel processing system 525, and display device(s) 545. The display device(s) 545 may include a display (e.g., a monitor, a touch screen, a television screen, a heads-up-display (HUD), other display types, or a combination thereof), speakers, and/or other presentation components. The display device(s) 545 may receive data from other components (e.g., the parallel processing system 525, the CPU(s) 530, etc.), and output the data (e.g., as an image, video, sound, etc.).

The network interface 535 may enable the system 565 to be logically coupled to other devices including the input devices 560, the display device(s) 545, and/or other components, some of which may be built in to (e.g., integrated in) the system 565. Illustrative input devices 560 include a microphone, mouse, keyboard, joystick, game pad, game controller, satellite dish, scanner, printer, wireless device, etc. The input devices 560 may provide a natural user interface (NUI) that processes air gestures, voice, or other physiological inputs generated by a user. In some instances, inputs may be transmitted to an appropriate network element for further processing. An NUI may implement any combination of speech recognition, stylus recognition, facial recognition, biometric recognition, gesture recognition both on screen and adjacent to the screen, air gestures, head and eye tracking, and touch recognition (as described in more detail below) associated with a display of the system 565. The system 565 may be include depth cameras, such as stereoscopic camera systems, infrared camera systems, RGB camera systems, touchscreen technology, and combinations of these, for gesture detection and recognition. Additionally, the system 565 may include accelerometers or gyroscopes (e.g., as part of an inertia measurement unit (IMU)) that enable detection of motion. In some examples, the output of the accelerometers or gyroscopes may be used by the system 565 to render immersive augmented reality or virtual reality.

Further, the system 565 may be coupled to a network (e.g., a telecommunications network, local area network (LAN), wireless network, wide area network (WAN) such as the Internet, peer-to-peer network, cable network, or the like) through a network interface 535 for communication purposes. The system 565 may be included within a distributed network and/or cloud computing environment.

The network interface 535 may include one or more receivers, transmitters, and/or transceivers that enable the system 565 to communicate with other computing devices via an electronic communication network, included wired and/or wireless communications. The network interface 535 may be implemented as a network interface controller (NIC) that includes one or more data processing units (DPUs) to perform operations such as (for example and without limitation) packet parsing and accelerating network processing and communication. The network interface 535 may include components and functionality to enable communication over any of a number of different networks, such as wireless networks (e.g., Wi-Fi, Z-Wave, Bluetooth, Bluetooth LE, ZigBee, etc.), wired networks (e.g., communicating over Ethernet or InfiniBand), low-power wide-area networks (e.g., LoRaWAN, SigFox, etc.), and/or the Internet.

The system 565 may also include a secondary storage (not shown). The secondary storage includes, for example, a hard disk drive and/or a removable storage drive, representing a floppy disk drive, a magnetic tape drive, a compact disk drive, digital versatile disk (DVD) drive, recording device, universal serial bus (USB) flash memory. The removable storage drive reads from and/or writes to a removable storage unit in a well-known manner. The system 565 may also include a hard-wired power supply, a battery power supply, or a combination thereof (not shown). The power supply may provide power to the system 565 to enable the components of the system 565 to operate.

Each of the foregoing modules and/or devices may even be situated on a single semiconductor platform to form the system 565. Alternately, the various modules may also be situated separately or in various combinations of semiconductor platforms per the desires of the user. While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

### Example Network Environments

Network environments suitable for use in implementing embodiments of the disclosure may include one or more client devices, servers, network attached storage (NAS), other backend devices, and/or other device types. The client devices, servers, and/or other device types (e.g., each device) may be implemented on one or more instances of the processing system 500 of FIG. 4 and/or exemplary system 565 of FIG. 5A—e.g., each device may include similar components, features, and/or functionality of the processing system 500 and/or exemplary system 565.

Components of a network environment may communicate with each other via a network(s), which may be wired, wireless, or both. The network may include multiple networks, or a network of networks. By way of example, the network may include one or more Wide Area Networks (WANs), one or more Local Area Networks (LANs), one or more public networks such as the Internet and/or a public switched telephone network (PSTN), and/or one or more private networks. Where the network includes a wireless telecommunications network, components such as a base station, a communications tower, or even access points (as well as other components) may provide wireless connectivity.

Compatible network environments may include one or more peer-to-peer network environments—in which case a server may not be included in a network environment—and one or more client-server network environments—in which case one or more servers may be included in a network environment. In peer-to-peer network environments, functionality described herein with respect to a server(s) may be implemented on any number of client devices.

In at least one embodiment, a network environment may include one or more cloud-based network environments, a distributed computing environment, a combination thereof, etc. A cloud-based network environment may include a framework layer, a job scheduler, a resource manager, and a distributed file system implemented on one or more of servers, which may include one or more core network servers and/or edge servers. A framework layer may include a framework to support software of a software layer and/or one or more application(s) of an application layer. The software or application(s) may respectively include web-based service software or applications. In embodiments, one or more of the client devices may use the web-based service software or applications (e.g., by accessing the service software and/or applications via one or more application programming interfaces (APIs)). The framework layer may be, but is not limited to, a type of free and open-source software web application framework such as that may use a distributed file system for large-scale data processing (e.g., “big data”).

A cloud-based network environment may provide cloud computing and/or cloud storage that carries out any combination of computing and/or data storage functions described herein (or one or more portions thereof). Any of these various functions may be distributed over multiple locations from central or core servers (e.g., of one or more data centers that may be distributed across a state, a region, a country, the globe, etc.). If a connection to a user (e.g., a client device) is relatively close to an edge server(s), a core server(s) may designate at least a portion of the functionality to the edge server(s). A cloud-based network environment may be private (e.g., limited to a single organization), may be public (e.g., available to many organizations), and/or a combination thereof (e.g., a hybrid cloud environment).

The client device(s) may include at least some of the components, features, and functionality of the example processing system 500 of FIG. 4 and/or exemplary system 565 of FIG. 5A. By way of example and not limitation, a client device may be embodied as a Personal Computer (PC), a laptop computer, a mobile device, a smartphone, a tablet computer, a smart watch, a wearable computer, a Personal Digital Assistant (PDA), an MP3 player, a virtual reality headset, a Global Positioning System (GPS) or device, a video player, a video camera, a surveillance device or system, a vehicle, a boat, a flying vessel, a virtual machine, a drone, a robot, a handheld communications device, a hospital device, a gaming device or system, an entertainment system, a vehicle computer system, an embedded system controller, a remote control, an appliance, a consumer electronic device, a workstation, an edge device, any combination of these delineated devices, or any other suitable device.

### Machine Learning

Deep neural networks (DNNs) developed on processors, such as the PPU 400 have been used for diverse use cases, from self-driving cars to faster drug development, from automatic image captioning in online image databases to smart real-time language translation in video chat applications. Deep learning is a technique that models the neural learning process of the human brain, continually learning, continually getting smarter, and delivering more accurate results more quickly over time. A child is initially taught by an adult to correctly identify and classify various shapes, eventually being able to identify shapes without any coaching. Similarly, a deep learning or neural learning system needs to be trained in object recognition and classification for it get smarter and more efficient at identifying basic objects, occluded objects, etc., while also assigning context to objects.

At the simplest level, neurons in the human brain look at various inputs that are received, importance levels are assigned to each of these inputs, and output is passed on to other neurons to act upon. An artificial neuron is the most basic model of a neural network. In one example, a neuron may receive one or more inputs that represent various features of an object that the neuron is being trained to recognize and classify, and each of these features is assigned a certain weight based on the importance of that feature in defining the shape of an object.

A deep neural network (DNN) model includes multiple layers of many connected nodes (e.g., neurons, Boltzmann machines, radial basis functions, convolutional layers, etc.) that can be trained with enormous amounts of input data to quickly solve complex problems with high accuracy. In one example, a first layer of the DNN model breaks down an input image of an automobile into various sections and looks for basic patterns such as lines and angles. The second layer assembles the lines to look for higher level patterns such as wheels, windshields, and mirrors. The next layer identifies the type of vehicle, and the final few layers generate a label for the input image, identifying the model of a specific automobile brand.

Once the DNN is trained, the DNN can be deployed and used to identify and classify objects or patterns in a process known as inference. Examples of inference (the process through which a DNN extracts useful information from a given input) include identifying handwritten numbers on checks deposited into ATM machines, identifying images of friends in photos, delivering movie recommendations to over fifty million users, identifying and classifying different types of automobiles, pedestrians, and road hazards in driverless cars, or translating human speech in real-time.

During training, data flows through the DNN in a forward propagation phase until a prediction is produced that indicates a label corresponding to the input. If the neural network does not correctly label the input, then errors between the correct label and the predicted label are analyzed, and the weights are adjusted for each feature during a backward propagation phase until the DNN correctly labels the input and other inputs in a training dataset. Training complex neural networks requires massive amounts of parallel computing performance, including floating-point multiplications and additions that are supported by the PPU 400. Inferencing is less compute-intensive than training, being a latency-sensitive process where a trained neural network is applied to new inputs it has not seen before to classify images, detect emotions, identify recommendations, recognize and translate speech, and generally infer new information.

Neural networks rely heavily on matrix math operations, and complex multi-layered networks require tremendous amounts of floating-point performance and bandwidth for both efficiency and speed. With thousands of processing cores, optimized for matrix math operations, and delivering tens to hundreds of TFLOPS of performance, the PPU 400 is a computing platform capable of delivering performance required for deep neural network-based artificial intelligence and machine learning applications.

Furthermore, images generated applying one or more of the techniques disclosed herein may be used to train, test, or certify DNNs used to recognize objects and environments in the real world. Such images may include scenes of roadways, factories, buildings, urban settings, rural settings, humans, animals, and any other physical object or real-world setting.

Such images may be used to train, test, or certify DNNs that are employed in machines or robots to manipulate, handle, or modify physical objects in the real world. Furthermore, such images may be used to train, test, or certify DNNs that are employed in autonomous vehicles to navigate and move the vehicles through the real world. Additionally, images generated applying one or more of the techniques disclosed herein may be used to convey information to users of such machines, robots, and vehicles.

FIG. 5B illustrates components of an exemplary system 555 that can be used to train and utilize machine learning, in accordance with at least one embodiment. As will be discussed, various components can be provided by various combinations of computing devices and resources, or a single computing system, which may be under control of a single entity or multiple entities. Further, aspects may be triggered, initiated, or requested by different entities. In at least one embodiment training of a neural network might be instructed by a provider associated with provider environment 506, while in at least one embodiment training might be requested by a customer or other user having access to a provider environment through a client device 502 or other such resource. In at least one embodiment, training data (or data to be analyzed by a trained neural network) can be provided by a provider, a user, or a third party content provider 524. In at least one embodiment, client device 502 may be a vehicle or object that is to be navigated on behalf of a user, for example, which can submit requests and/or receive instructions that assist in navigation of a device.

In at least one embodiment, requests are able to be submitted across at least one network 504 to be received by a provider environment 506. In at least one embodiment, a client device may be any appropriate electronic and/or computing devices enabling a user to generate and send such requests, such as, but not limited to, desktop computers, notebook computers, computer servers, smartphones, tablet computers, gaming consoles (portable or otherwise), computer processors, computing logic, and set-top boxes. Network(s) 504 can include any appropriate network for transmitting a request or other such data, as may include Internet, an intranet, an Ethernet, a cellular network, a local area network (LAN), a wide area network (WAN), a personal area network (PAN), an ad hoc network of direct wireless connections among peers, and so on.

In at least one embodiment, requests can be received at an interface layer 508, which can forward data to a training and inference manager 532, in this example. The training and inference manager 532 can be a system or service including hardware and software for managing requests and service corresponding data or content, in at least one embodiment, the training and inference manager 532 can receive a request to train a neural network, and can provide data for a request to a training module 512. In at least one embodiment, training module 512 can select an appropriate model or neural network to be used, if not specified by the request, and can train a model using relevant training data. In at least one embodiment, training data can be a batch of data stored in a training data repository 514, received from client device 502, or obtained from a third party provider 524. In at least one embodiment, training module 512 can be responsible for training data. A neural network can be any appropriate network, such as a recurrent neural network (RNN) or convolutional neural network (CNN). Once a neural network is trained and successfully evaluated, a trained neural network can be stored in a model repository 516, for example, that may store different models or networks for users, applications, or services, etc. In at least one embodiment, there may be multiple models for a single application or entity, as may be utilized based on a number of different factors.

In at least one embodiment, at a subsequent point in time, a request may be received from client device 502 (or another such device) for content (e.g., path determinations) or data that is at least partially determined or impacted by a trained neural network. This request can include, for example, input data to be processed using a neural network to obtain one or more inferences or other output values, classifications, or predictions, or for at least one embodiment, input data can be received by interface layer 508 and directed to inference module 518, although a different system or service can be used as well. In at least one embodiment, inference module 518 can obtain an appropriate trained network, such as a trained deep neural network (DNN) as discussed herein, from model repository 516 if not already stored locally to inference module 518. Inference module 518 can provide data as input to a trained network, which can then generate one or more inferences as output. This may include, for example, a classification of an instance of input data. In at least one embodiment, inferences can then be transmitted to client device 502 for display or other communication to a user. In at least one embodiment, context data for a user may also be stored to a user context data repository 522, which may include data about a user which may be useful as input to a network in generating inferences, or determining data to return to a user after obtaining instances. In at least one embodiment, relevant data, which may include at least some of input or inference data, may also be stored to a local database 534 for processing future requests. In at least one embodiment, a user can use account information or other information to access resources or functionality of a provider environment. In at least one embodiment, if permitted and available, user data may also be collected and used to further train models, in order to provide more accurate inferences for future requests. In at least one embodiment, requests may be received through a user interface to a machine learning application 526 executing on client device 502, and results displayed through a same interface. A client device can include resources such as a processor 528 and memory 562 for generating a request and processing results or a response, as well as at least one data storage element 552 for storing data for machine learning application 526.

In at least one embodiment a processor 528 (or a processor of training module 512 or inference module 518) will be a central processing unit (CPU). As mentioned, however, resources in such environments can utilize GPUs to process data for at least certain types of requests. With thousands of cores, GPUs, such as PPU 400 are designed to handle substantial parallel workloads and, therefore, have become popular in deep learning for training neural networks and generating predictions. While use of GPUs for offline builds has enabled faster training of larger and more complex models, generating predictions offline implies that either request-time input features cannot be used or predictions must be generated for all permutations of features and stored in a lookup table to serve real-time requests. If a deep learning framework supports a CPU-mode and a model is small and simple enough to perform a feed-forward on a CPU with a reasonable latency, then a service on a CPU instance could host a model. In this case, training can be done offline on a GPU and inference done in real-time on a CPU. If a CPU approach is not viable, then a service can run on a GPU instance. Because GPUs have different performance and cost characteristics than CPUs, however, running a service that offloads a runtime algorithm to a GPU can require it to be designed differently from a CPU based service.

In at least one embodiment, video data can be provided from client device 502 for enhancement in provider environment 506. In at least one embodiment, video data can be processed for enhancement on client device 502. In at least one embodiment, video data may be streamed from a third party content provider 524 and enhanced by third party content provider 524, provider environment 506, or client device 502. In at least one embodiment, video data can be provided from client device 502 for use as training data in provider environment 506. In at least one embodiment, supervised and/or unsupervised training can be performed by the client device 502 and/or the provider environment 506. In at least one embodiment, a set of training data 514 (e.g., classified or labeled data) is provided as input to function as training data.

In at least one embodiment, training data can include instances of at least one type of object for which a neural network is to be trained, as well as information that identifies that type of object. In at least one embodiment, training data might include a set of images that each includes a representation of a type of object, where each image also includes, or is associated with, a label, metadata, classification, or other piece of information identifying a type of object represented in a respective image. Various other types of data may be used as training data as well, as may include text data, audio data, video data, and so on. In at least one embodiment, training data 514 is provided as training input to a training module 512. In at least one embodiment, training module 512 can be a system or service that includes hardware and software, such as one or more computing devices executing a training application, for training a neural network (or other model or algorithm, etc.). In at least one embodiment, training module 512 receives an instruction or request indicating a type of model to be used for training, in at least one embodiment, a model can be any appropriate statistical model, network, or algorithm useful for such purposes, as may include an artificial neural network, deep learning algorithm, learning classifier, Bayesian network, and so on. In at least one embodiment, training module 512 can select an initial model, or other untrained model, from an appropriate repository 516 and utilize training data 514 to train a model, thereby generating a trained model (e.g., trained deep neural network) that can be used to classify similar types of data, or generate other such inferences. In at least one embodiment where training data is not used, an appropriate initial model can still be selected for training on input data per training module 512.

In at least one embodiment, a model can be trained in a number of different ways, as may depend in part upon a type of model selected. In at least one embodiment, a machine learning algorithm can be provided with a set of training data, where a model is a model artifact created by a training process. In at least one embodiment, each instance of training data contains a correct answer (e.g., classification), which can be referred to as a target or target attribute. In at least one embodiment, a learning algorithm finds patterns in training data that map input data attributes to a target, an answer to be predicted, and a machine learning model is output that captures these patterns. In at least one embodiment, a machine learning model can then be used to obtain predictions on new data for which a target is not specified.

In at least one embodiment, training and inference manager 532 can select from a set of machine learning models including binary classification, multiclass classification, generative, and regression models. In at least one embodiment, a type of model to be used can depend at least in part upon a type of target to be predicted.

### Graphics Processing Pipeline

In an embodiment, the PPU 400 comprises a graphics processing unit (GPU). The PPU 400 is configured to receive commands that specify shader programs for processing graphics data. Graphics data may be defined as a set of primitives such as points, lines, triangles, quads, triangle strips, and the like. Typically, a primitive includes data that specifies a number of vertices for the primitive (e.g., in a model-space coordinate system) as well as attributes associated with each vertex of the primitive. The PPU 400 can be configured to process the graphics primitives to generate a frame buffer (e.g., pixel data for each of the pixels of the display).

An application writes model data for a scene (e.g., a collection of vertices and attributes) to a memory such as a system memory or memory 404. The model data defines each of the objects that may be visible on a display. The application then makes an API call to the driver kernel that requests the model data to be rendered and displayed. The driver kernel reads the model data and writes commands to the one or more streams to perform operations to process the model data. The commands may reference different shader programs to be implemented on the processing units within the PPU 400 including one or more of a vertex shader, hull shader, domain shader, geometry shader, and a pixel shader. For example, one or more of the processing units may be configured to execute a vertex shader program that processes a number of vertices defined by the model data. In an embodiment, the different processing units may be configured to execute different shader programs concurrently. For example, a first subset of processing units may be configured to execute a vertex shader program while a second subset of processing units may be configured to execute a pixel shader program. The first subset of processing units processes vertex data to produce processed vertex data and writes the processed vertex data to the L2 cache and/or the memory 404. After the processed vertex data is rasterized (e.g., transformed from three-dimensional data into two-dimensional data in screen space) to produce fragment data, the second subset of processing units executes a pixel shader to produce processed fragment data, which is then blended with other processed fragment data and written to the frame buffer in memory 404. The vertex shader program and pixel shader program may execute concurrently, processing different data from the same scene in a pipelined fashion until all of the model data for the scene has been rendered to the frame buffer. Then, the contents of the frame buffer are transmitted to a display controller for display on a display device.

Images generated applying one or more of the techniques disclosed herein may be displayed on a monitor or other display device. In some embodiments, the display device may be coupled directly to the system or processor generating or rendering the images. In other embodiments, the display device may be coupled indirectly to the system or processor such as via a network. Examples of such networks include the Internet, mobile telecommunications networks, a WIFI network, as well as any other wired and/or wireless networking system. When the display device is indirectly coupled, the images generated by the system or processor may be streamed over the network to the display device. Such streaming allows, for example, video games or other applications, which render images, to be executed on a server, a data center, or in a cloud-based computing environment and the rendered images to be transmitted and displayed on one or more user devices (such as a computer, video game console, smartphone, other mobile device, etc.) that are physically separate from the server or data center. Hence, the techniques disclosed herein can be applied to enhance the images that are streamed and to enhance services that stream images such as NVIDIA Geforce Now (GFN), Google Stadia, and the like.

### Example Streaming System

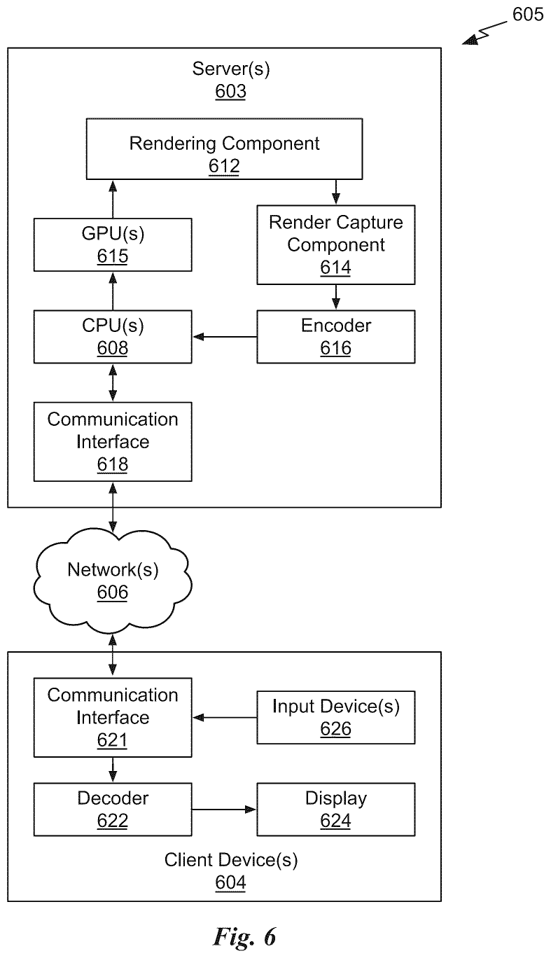

FIG. 6 is an example system diagram for a streaming system 605, in accordance with some embodiments of the present disclosure. FIG. 6 includes server(s) 603 (which may include similar components, features, and/or functionality to the example processing system 500 of FIG. 4 and/or exemplary system 565 of FIG. 5A), client device(s) 604 (which may include similar components, features, and/or functionality to the example processing system 500 of FIG. 4 and/or exemplary system 565 of FIG. 5A), and network(s) 606 (which may be similar to the network(s) described herein). In some embodiments of the present disclosure, the system 605 may be implemented.

In an embodiment, the streaming system 605 is a game streaming system and the server(s) 603 are game server(s). In the system 605, for a game session, the client device(s) 604 may only receive input data in response to inputs to the input device(s) 626, transmit the input data to the server(s) 603, receive encoded display data from the server(s) 603, and display the display data on the display 624. As such, the more computationally intense computing and processing is offloaded to the server(s) 603 (e.g., rendering—in particular ray or path tracing—for graphical output of the game session is executed by the GPU(s) 615 of the server(s) 603). In other words, the game session is streamed to the client device(s) 604 from the server(s) 603, thereby reducing the requirements of the client device(s) 604 for graphics processing and rendering.

For example, with respect to an instantiation of a game session, a client device 604 may be displaying a frame of the game session on the display 624 based on receiving the display data from the server(s) 603. The client device 604 may receive an input to one of the input device(s) 626 and generate input data in response. The client device 604 may transmit the input data to the server(s) 603 via the communication interface 621 and over the network(s) 606 (e.g., the Internet), and the server(s) 603 may receive the input data via the communication interface 618. The CPU(s) 608 may receive the input data, process the input data, and transmit data to the GPU(s) 615 that causes the GPU(s) 615 to generate a rendering of the game session. For example, the input data may be representative of a movement of a character of the user in a game, firing a weapon, reloading, passing a ball, turning a vehicle, etc. The rendering component 612 may render the game session (e.g., representative of the result of the input data) and the render capture component 614 may capture the rendering of the game session as display data (e.g., as image data capturing the rendered frame of the game session). The rendering of the game session may include ray or path-traced lighting and/or shadow effects, computed using one or more parallel processing units-such as GPUs, which may further employ the use of one or more dedicated hardware accelerators or processing cores to perform ray or path-tracing techniques-of the server(s) 603. The encoder 616 may then encode the display data to generate encoded display data and the encoded display data may be transmitted to the client device 604 over the network(s) 606 via the communication interface 618. The client device 604 may receive the encoded display data via the communication interface 621 and the decoder 622 may decode the encoded display data to generate the display data. The client device 604 may then display the display data via the display 624.

It is noted that the techniques described herein may be embodied in executable instructions stored in a computer readable medium for use by or in connection with a processor-based instruction execution machine, system, apparatus, or device. It will be appreciated by those skilled in the art that, for some embodiments, various types of computer-readable media can be included for storing data. As used herein, a “computer-readable medium” includes one or more of any suitable media for storing the executable instructions of a computer program such that the instruction execution machine, system, apparatus, or device may read (or fetch) the instructions from the computer-readable medium and execute the instructions for carrying out the described embodiments. Suitable storage formats include one or more of an electronic, magnetic, optical, and electromagnetic format. A non-exhaustive list of conventional exemplary computer-readable medium includes: a portable computer diskette; a random-access memory (RAM); a read-only memory (ROM); an erasable programmable read only memory (EPROM); a flash memory device; and optical storage devices, including a portable compact disc (CD), a portable digital video disc (DVD), and the like.

The arrangement of components illustrated in the attached Figures are for illustrative purposes and that other arrangements are possible. For example, one or more of the elements described herein may be realized, in whole or in part, as an electronic hardware component. Other elements may be implemented in software, hardware, or a combination of software and hardware. Moreover, some or all of these other elements may be combined, some may be omitted altogether, and additional components may be added while still achieving the functionality described herein. Thus, the subject matter described herein may be embodied in many different variations, and all such variations are contemplated to be within the scope of the claims.

To facilitate an understanding of the subject matter described herein, many aspects are described in terms of sequences of actions. Various actions may be performed by specialized circuits or circuitry, by program instructions being executed by one or more processors, or by a combination of both. The description herein of any sequence of actions is not intended to imply that the specific order described for performing that sequence must be followed. All methods described herein may be performed in any suitable order unless otherwise indicated herein or otherwise clearly contradicted by context.

The use of the terms “a” and “an” and “the” and similar references in the context of describing the subject matter (particularly in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. Furthermore, the foregoing description is for the purpose of illustration only, and not for the purpose of limitation, as the scope of protection sought is defined by the claims as set forth hereinafter together with any equivalents thereof. The use of any and all examples, or exemplary language (e.g., “such as”) provided herein, is intended merely to better illustrate the subject matter and does not pose a limitation on the scope of the subject matter unless otherwise claimed. The use of the term “based on” and other like phrases indicating a condition for bringing about a result, both in the claims and in the written description, is not intended to foreclose any other conditions that bring about that result. No language in the specification should be construed as indicating any non-claimed element as essential to the practice of the invention as claimed.

What is claimed is:

1. A system comprising:
one or more processors to perform tokenization of visual input and reconstruction of visual output using one or more neural networks comprising:
a tokenizer encoder, comprising:
a wavelet transform block, configured to apply a wavelet transform to the visual input to generate a first intermediate wavelet domain representation, and
one or more downsampling blocks, configured to obtain the intermediate wavelet domain representation of the visual input and generate a set of input tokens; and
a tokenizer decoder, comprising:
one or more upsampling blocks, configured to obtain a set of output tokens and generate a second intermediate wavelet domain representation, and
an inverse wavelet transform block, configured to apply an inverse wavelet transform to the second intermediate wavelet domain representation to generate the visual output; and
one or more memories to store parameters associated with the one or more neural networks.

2. The system according to claim 1, wherein the one or more neural networks further comprise a generative AI model configured to process the set of input tokens to generate the set of output tokens.

3. The system according to claim 1, wherein at least one of the one or more downsampling blocks includes a causal spatio-temporal attention layer, and
wherein at least one of the one or more upsampling blocks includes a causal spatio-temporal attention layer.

4. The system according to claim 1, wherein the wavelet transform block is configured to apply a Haar wavelet transform to the visual input, and
wherein the inverse wavelet transform block is configured to apply an inverse Haar wavelet transform to the second intermediate wavelet domain representation.

5. The system according to claim 1, wherein at least one of the one or more downsampling blocks comprises a causal residual subblock, a causal downsampling subblock, and a causal spatio-temporal attention subblock.

6. The system according to claim 1, wherein at least one of the one or more upsampling blocks comprises a causal residual subblock, a causal upsampling subblock, and a causal spatio-temporal attention subblock.

7. The system according to claim 1, wherein the tokenizer encoder and the tokenizer decoder are trained via an end-to-end learning process, the end-to-end learning process comprising:
tokenizing, by the tokenizer encoder, sample visual input;
reconstructing, by the tokenizer decoder, tokenized sample visual input;
computing, by comparing the sample visual input with the reconstructed tokenized sample visual input, a model loss; and
updating, based on gradients of the model loss, parameters associated with the tokenizer encoder and parameters associated with the tokenizer decoder.

8. The system according to claim 7, wherein the end-to-end learning process is a multi-stage learning process,
wherein, during a first stage of the multi-stage learning process, a first loss function is used to compute the model loss, and
wherein, during a second stage of the multi-stage learning process, a second loss function is used to compute the model loss.

9. The system according to claim 8, wherein the first loss function is a combination loss function comprising (i) an L1 loss term that minimizes a pixel-wise RGB difference between the training image/video and the reconstruction thereof and (ii) a perceptual loss term; and/or
wherein the second loss function is a combination loss function comprising (i) an optical flow (OF) loss and (ii) a Gram-matrix (GM) loss.

10. The system according to claim 8, wherein, during a fine-tuning stage of the multi-stage learning process, an adversarial loss function is used to compute the model loss.

11. A computer-implemented method for tokenizing visual input, the method comprising:
obtaining the visual input, wherein the visual input is provided in a pixel space;
applying a wavelet transform to the visual input to transform the visual input from the pixel space to a wavelet domain, thereby generating an intermediate wavelet domain representation of the visual input; and
encoding the intermediate wavelet domain representation of the visual input to generate a plurality of tokens, each token being an embedding in a latent feature space.

12. The method according to claim 11, wherein the applying the wavelet transform to the visual input and/or the encoding the intermediate wavelet domain representation provides a spatial compression factor and a temporal compression factor.

13. The method according to claim 11, wherein the plurality of tokens are one of continuous tokens or discrete tokens.

14. The method according to claim 11, further comprising processing, by a generative AI model, the plurality of tokens to generate a plurality of output tokens, each output token being an embedding in the latent feature space.

15. The method according to claim 14, further comprising:
decoding the plurality of output tokens to generate a wavelet domain representation of AI model output; and
applying an inverse wavelet transform to the wavelet domain representation of the AI model output to generate a pixel-space representation of the AI model output.

16. The method according to claim 11, wherein the applying the wavelet transform to the visual input and the encoding the intermediate wavelet domain representation of the visual input are performed by a tokenizer encoder.

17. The method according to claim 16, wherein the tokenizer encoder comprises:
a wavelet transform block, configured to apply a wavelet transform to the visual input to generate a first intermediate wavelet domain representation, and
one or more downsampling blocks, configured to obtain the intermediate wavelet domain representation of the visual input and generate a set of input tokens.

18. The method according to claim 17, wherein at least one of the one or more downsampling blocks comprises a causal residual subblock, a causal downsampling subblock, and a causal spatio-temporal attention subblock.

19. The method according to claim 15, wherein the applying the wavelet transform to the visual input and the encoding the intermediate wavelet domain representation of the visual input are performed by a tokenizer encoder, and
wherein the decoding the plurality of output tokens and the applying the inverse wavelet transform to the wavelet domain representation of the AI model output are performed by a tokenizer decoder.

20. The method according to claim 19, wherein the tokenizer encoder comprises:
a wavelet transform block, configured to apply a wavelet transform to the visual input to generate a first intermediate wavelet domain representation, and
one or more downsampling blocks, configured to obtain the intermediate wavelet domain representation of the visual input and generate a set of input tokens, and
wherein the tokenizer decoder comprises:
one or more upsampling blocks, configured to obtain a set of output tokens and generate a second intermediate wavelet domain representation, and
an inverse wavelet transform block, configured to apply an inverse wavelet transform to the second intermediate wavelet domain representation to generate visual output.

21. The method according to claim 20, wherein at least one of the one or more downsampling blocks comprises a causal residual subblock, a causal downsampling subblock, and a causal spatio-temporal attention subblock, and
wherein at least one of the one or more upsampling blocks comprises a causal residual subblock, a causal upsampling subblock, and a causal spatio-temporal attention subblock.

22. The method according to claim 19, wherein the tokenizer encoder and the tokenizer decoder are trained via an end-to-end learning process, the end-to-end learning process comprising:
tokenizing, by the tokenizer encoder, sample visual input;
reconstructing, by the tokenizer decoder, tokenized sample visual input;
computing, by comparing the sample visual input with the reconstructed tokenized sample visual input, a model loss; and
updating, based on gradients of the model loss, parameters associated with the tokenizer encoder and parameters associated with the tokenizer decoder.

23. The method according to claim 22, wherein the end-to-end learning process is a multi-stage learning process,
wherein, during a first stage of the multi-stage learning process, a first loss function is used to compute the model loss, and
wherein, during a second stage of the multi-stage learning process, a second loss function is used to compute the model loss.

24. Non-transitory processor-readable media having stored thereon executable instructions that, when executed by processing circuitry, cause the processing circuitry to perform a method for tokenizing visual input, the method comprising:
obtaining the visual input, wherein the visual input is provided in a pixel space;
applying a wavelet transform to the visual input to transform the visual input from the pixel space to a wavelet domain, thereby generating an intermediate wavelet domain representation of the visual input; and
encoding the intermediate wavelet domain representation of the visual input to generate a plurality of tokens, each token being an embedding in a latent feature space.

25. The non-transitory processor-readable media of claim 24, wherein the method further comprises:
processing, by a generative AI model, the plurality of tokens to generate a plurality of output tokens, each output token being an embedding in the latent feature space decoding the plurality of output tokens to generate a wavelet domain representation of AI model output; and
applying an inverse wavelet transform to the wavelet domain representation of the AI model output to generate a pixel-space representation of the generative AI model output.
